(19) United States
(12) Patent Application Publication
(10) Pub. No.: US 2011/0077929 A1
(43) Pub. Date: Mar. 31, 2011

(54) METHOD AND SYSTEM FOR MODELING DURABILITY OF INSECTICIDAL CROP TRAITS

(75) Inventors: Bruce H. Stanley, Wilmington, DE (US); Zaiqi Pan, Hockessin, DE (US); John L. Flexner, Landenberg, PA (US); David W. Onstad, Mahomet, IL (US)

(73) Assignees: Pioneer Hi-Bred International, Inc.; E.I. du Pont de Nemours and Company

(21) Appl. No.: 12/890,516

(22) Filed: Sep. 24, 2010

Related U.S. Application Data
(60) Provisional application No. 61/245,830, filed on Sep. 25, 2009.

(51) Int. Cl. G06G 7/60

(52) U.S. Cl. 703/11

(57) ABSTRACT

Systems, methods and other means for evaluating durability of genetic traits for the control of damage by pests are provided. Inputs parameters associated with the genetic traits, pests, and one or more fields may be received by a computer and/or other type of machine, which may apply a computer-implemented model to determine, e.g., durability of the genetic traits. Some embodiments may also or instead include an output associated with, e.g., the durability. The computer-implemented model may provide, in some embodiments, for modeling dynamic movement of the pests within a Bt field and one or more of the fields being Bt fields. The computer-implemented model may also or instead provide, in some embodiments, for modeling blended refuge seed products.

### CROSS-REFERENCE TO RELATED APPLICATION

This patent application claims priority to U.S. Provisional Patent Application No. 61/245,830, filed Sep. 25, 2009, titled “METHOD AND SYSTEM FOR MODELING DURABILITY OF INSECTICIDAL CROP TRAITS,” which is hereby incorporated by reference in its entirety.

### FIELD

Embodiments discussed herein relate to modeling the impact of one or more types of organisms on one or more types of plants.

### BACKGROUND

Insect pests are a major factor in the loss of the world's agricultural crops. For example, armyworm feeding, black cutworm damage, or European corn borer damage can be economically devastating to agricultural producers. Insect pest-related crop loss from corn rootworm alone has reached about one billion dollars a year in damage and control expenses. Economically important pests include, but are not limited to, agronomic, forest, greenhouse, nursery, ornamentals, food and fiber, public and animal health, domestic and commercial structure, household, and stored product pests. Insect pests include, but are not limited to, insects selected from the orders Coleoptera, Diptera, Hymenoptera, Lepidoptera, Mallophaga, Homoptera, Hemiptera, Orthoptera, Thysanoptera, Dermaptera, Isoptera, Anoplura, Siphonaptera, and Trichoptera.

Traditionally, the primary method for impacting insect pest populations is the application of broad-spectrum chemical insecticides. However, consumers and government regulators alike are becoming increasingly concerned with the environmental hazards associated with the production and use of synthetic chemical pesticides. Because of such concerns, regulators have banned or limited the use of some of the more hazardous pesticides.

Certain species of microorganisms of the genus Bacillus are known to possess pesticidal activity against a broad range of insect pests including Lepidoptera, Diptera, Coleoptera, Hemiptera, and others. Bacillus thuringiensis (“Bt”) and Bacillus papilliae are among the most successful biocontrol agents discovered to date. Insect pathogenicity has also been attributed to strains of B. larvae, B. lentimorbus, B. sphaericus (1989) (see Harwook, ed. (1989), Bacillus, Plenum Press, p. 306) and B. cereus (see PCT Publication WO 96/10083). Pesticidal activity appears to be concentrated in parasporal crystalline protein inclusions, although pesticidal proteins have also been isolated from the vegetative growth stage of Bacillus.

Microbial insecticides, particularly those obtained from Bacillus strains, have played an important role in agriculture as alternatives to chemical pest control. Recently, agricultural scientists have developed crop plants with enhanced insect resistance by genetically engineering crop plants to produce pesticidal proteins from Bacillus. For example, corn and cotton plants have been genetically engineered to produce pesticidal proteins isolated from strains of Bt (see Aronson (2002) Cell Mol. Life Sci. 59(3):417-425; Schnepf et al. (1998) Microbiol Mol Biol Rev. 62(3):775-806). These genetically engineered crops are now widely used in American agriculture and have provided the farmer with an environmentally friendly alternative to traditional insect-control methods.

One issue associated with insect resistance traits relates to the durability of such traits. In some instances, the trait's durability may be described as being the duration that resistance allele frequency remains below a predetermined level, such as 50 percent. Pests may adapt to these traits thereby affecting the viability of these traits. Of even greater concern is that the use of such traits may accelerate the adaptation of insects to, for example, Bt-based insecticides. To ensure the sustainability of Bt crops as effective management tools, strategies that are designed to delay the onset of pest resistance are mandated by the U.S. Environmental Protection Agency.

One method of addressing these issues and concerns is known as the “high dose/refuge” strategy. There are two basic components to this strategy. First, the Bt trait should be high dose. This is achieved by having a protein toxin concentration which is higher, preferably significantly higher, than the concentration needed to kill ninety nine (99) percent of the Bt susceptible pest. Multiple toxins may be used to achieve this high dose. Due to the high dose of the Bt toxin, the surviving pests, if any, would be those rarely occurring individuals which are homozygous for alleles that impart resistance to the Bt toxin. The second component of the strategy is to plant a pest susceptible non-Bt crop refuge. The conventional approach has been for crop producers to plant a block of non-Bt refuge adjacent the Bt crop. The refuge is generally specified as a percent of the cropped area. The non-Bt refuge allows some Bt-susceptible pests to survive. The rarely occurring individuals which are homozygous for alleles that provide resistance to the Bt toxin predominately mate with those pests (such as those from the non-Bt refuge) which have not been exposed to the Bt toxin. The succeeding generation of pests would then have few of the homozygous individuals, thereby extending the durability of the Bt crop and delaying the development of pest resistance.

Despite recognition of and adoption of the high dose/refuge strategy, problems remain in its application and use. In addition, not all Bt traits are high dose. One of the problems associated with all Bt traits relates to predicting an appropriate size of refuge that is effective for extending the durability of the Bt trait. Another problem relates to determining the durability of crops with Bt traits under particular conditions.

Additionally, alternative approaches may be used instead of the block non-Bt refuge. One example of an alternative approach would be to use a strip refuge. Another example of an alternative approach can be used instead of using a block of non-Bt refuge adjacent to a Bt crop and includes the use of a blended refuge.

For example, the corn rootworm (“CRW,” Diabrotica spp.) is a significant agricultural pest of maize in North America. Transgenic maize that expresses insecticidal proteins from Bt to minimize yield loss due to CRW damage is widely planted in North America. The current resistance management strategy for CRW requires planting a refuge (i.e., maize not containing a Plant-Incorporated Protectant (“PIP”) for CRW control) grown in or adjacent to the CRW Bt maize field. This strategy is intended to provide a pool of susceptible rootworms to mate with any potentially resistant rootworms that survive exposure to the Bt maize.

### SUMMARY

Embodiments discuss herein include systems, methods, computer readable media and other means for evaluating the durability of genetic traits for the control of damage by pests. For example, some embodiments include receiving as inputs a plurality of input parameters associated with the genetic traits, the pests, and one or more fields. Embodiments may also include configuring a machine to execute a computer-implemented model that determines durability of the genetic traits. Outputs produced by embodiments discussed herein may be associated with the durability.

The computer-implemented model of some embodiments may provide for modeling the dynamic movement of the pests within a Bt-crop containing field and one or more adjacent fields which may or may not contain a Bt-crop. The computer-implemented model may provide for modeling the durability of blended refuge seed products.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram showing components of a system that may be configured to implement a computer-based model for assessing durability of pest resistance traits in accordance with some embodiments discussed herein;

FIG. 2 is a block diagram showing aspects of exemplary models that may be implemented by the system, such as that discussed in reference to FIG. 1;

FIG. 3A through FIG. 3N show examples of inputs for some models discussed herein in accordance with some embodiments discussed herein;

FIG. 4A through FIG. 4C show examples of outputs of some models discussed herein in accordance with some embodiments discussed herein;

FIG. 5 is process flow diagram showing an exemplary methodology in accordance with some embodiments discussed herein; and

FIG. 6 through FIG. 19 show tables of input parameters and outputted information in accordance with some embodiments discussed herein.

### DETAILED DESCRIPTION

Embodiments discussed herein may provide systems, methods, and other means for assessing the durability of blended refuge strategies, as well as, block refuge and/or strip refuge strategies. For example, while rootworm models have been developed to predict the durability of CRW resistant Bt maize, previous rootworm models have not incorporated the dynamic movement of refuge beetles once they arrive in the Bt field. Instead, as soon as refuge beetles met the edge of the Bt field, past models incorrectly assumed instantaneous and even distribution of those refuge beetles throughout the entire Bt field, typically modeled as 25-100 ha fields. See Onstad et al. 2001, Storer 2003, Onstad 2006a, Lefko et al. 2008a, Ives model in Heeringa and Bailey, 2009. This assumption of instantaneous random mating becomes increasingly unrealistic as the size of the Bt field increases or the shape of the field lengthens the distance between the adjacent refuge and the field's most distant border. To more predictably determine a trait's durability some embodiments discussed herein include a model that incorporates parameters that reflect more realistic pre-mating dispersal, mating, and oviposition, as well as provides a sensitivity analysis of dynamic movement of pests and the dynamic movement's effect on the durability of plants.

According to some exemplary embodiments, a data-driven, computer-implemented model can be provided that is configured to perform a rapid assessment on the durability of pest resistance traits in maize and/or to output a recommended optimization of use patterns, spatial geometries, genetic dispositions, and/or allele frequencies, among other things. One example of pest resistance traits are coleopteran pest resistance traits. Some models discussed herein include one or more rules. As referred to herein, each “rule” (some examples of which are discussed below) can comprise one or more algorithms (mathematical, logical, and/or any other type), conditional statements, and/or other data that may be used to represent a natural, man-made and/or other type of response to a given input.

Embodiments discussed herein relate to modeling the impact of one or more types of organisms on one or more types of plants. In some embodiments, the plant is stably transformed with a nucleotide construct comprising at least one nucleotide sequence operably linked to a promoter that drives expression in a plant cell. As used herein, the terms “transformed plant” and “transgenic plant” refer to a plant that comprises within its genome a heterologous polynucleotide. Generally, the heterologous polynucleotide is stably integrated within the genome of a transgenic or transformed plant such that the polynucleotide is passed on to successive generations. The heterologous polynucleotide may be integrated into the genome alone or as part of a recombinant expression cassette.

It is to be understood that as used herein the term “transgenic” includes any cell, cell line, callus, tissue, plant part, or plant the genotype of which has been altered by the presence of a heterologous nucleic acid including those transgenics initially so altered as well as those created by sexual crosses or asexual propagation from the initial transgenic. The term “transgenic” as used herein does not encompass the alteration of the genome (chromosomal or extra-chromosomal) by conventional plant breeding methods or by naturally occurring events such as random cross-fertilization, non-recombinant viral infection, non-recombinant bacterial transformation, non-recombinant transposition, or spontaneous mutation.

As used herein, the term “plant” includes whole plants, plant organs (e.g., leaves, stems, roots, etc.), seeds, plant cells, and progeny of same. Parts of transgenic plants are within the scope of the embodiments and comprise, for example, plant cells, protoplasts, tissues, callus, embryos as well as flowers, stems, fruits, leaves, and roots originating in transgenic plants or their progeny previously transformed with a DNA molecule and therefore consisting at least in part of transgenic cells.

As used herein, the term plant includes plant cells, plant protoplasts, plant cell tissue cultures from which plants can be regenerated, plant calli, plant clumps, and plant cells that are intact in plants or parts of plants such as embryos, pollen, ovules, seeds, leaves, flowers, branches, fruit, kernels, ears, cobs, husks, stalks, roots, root tips, anthers, and the like. The class of plants that can be used in the methods of the embodiments is generally as broad as the class of higher plants amenable to transformation techniques, including both monocotyledonous and dicotyledonous plants. Such plants include, for example, Solanum tuberosum and Zea mays.

While the embodiments do not depend on a particular biological mechanism for increasing the resistance of a plant to a plant pest, expression of the nucleotide sequences in a plant can result in the production of the pesticidal proteins and in an increase in the resistance of the plant to a plant pest. The plants of the embodiments find use in agriculture in methods for impacting insect pests. Certain embodiments provide transformed crop plants, such as, for example, maize plants, which find use in methods for impacting insect pests of the plant, such as, for example, European corn borer.

Examples of plants of interest include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, and conifers.

Vegetables include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and chrysanthemum. Conifers that may be employed in practicing the embodiments include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). Plants of the embodiments include crop plants (for example, corn, alfalfa, sunflower, Brassica, soybean, cotton, safflower, peanut, sorghum, wheat, millet, tobacco, etc.), such as corn and soybean plants.

Turf grasses include, but are not limited to: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerata); perennial ryegrass (Lolium perenne); red fescue (Festuca rubra); redtop (Agrostis alba); rough bluegrass (Poa trivialis); sheep fescue (Festuca ovina); smooth bromegrass (Bromus inermis); tall fescue (Festuca arundinacea); timothy (Phleum pratense); velvet bentgrass (Agrostis canina); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); blue gramma (Bouteloua gracilis); buffalo grass (Buchloe dactyloids); sideoats gramma (Bouteloua curtipendula).

Plants of interest include grain plants that provide seeds of interest, oil-seed plants, and leguminous plants. Seeds of interest include grain seeds, such as corn, wheat, barley, rice, sorghum, rye, millet, etc. Oil-seed plants include cotton, soybean, safflower, sunflower, Brassica, maize, alfalfa, palm, coconut, flax, castor, olive etc. Leguminous plants include beans and peas. Beans include guar, locust bean, fenugreek, soybean, garden beans, cowpea, mungbean, lima bean, fava bean, lentils, chickpea, etc.

Nucleotide sequences of interest include those encoding insecticidal proteins such as lipases, protease inhibitors, cysteine proteases, cyclotides, chitinases, scorpion toxins, spider toxins, globulins, lectins, patatins, Bacillus thuringiensis (Bt) crystal insecticidal proteins, Bacillus thuringiensis (Bt) vegetative insecticidal proteins (VIPs), Bacillus thuringiensis (Bt) binary proteins, Bacillus subtilis, toxin complexes for example, those from Bacillus thuringiensis, Serratia spp., Yersinia frederiksenii, Photorhabdus luminescens and Clostridium perfringes, insecticidal proteins from sea anemone and tropical plants, and shuffled variants of all of the above.

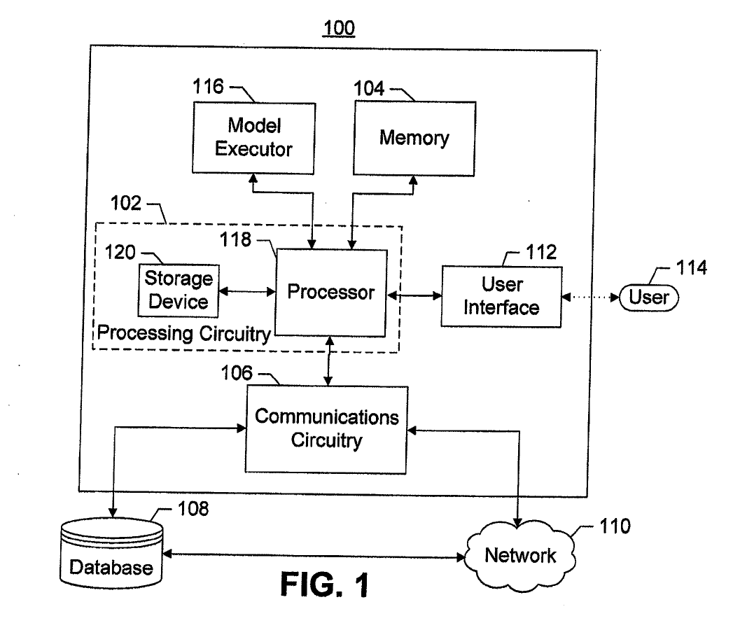

FIG. 1 is a block diagram showing components of one or more systems that may be configured to implement, for example, a computer-based model for assessing durability of pest resistance traits, among other things, in accordance with some embodiments discussed herein. In FIG. 1 computer system 100, which may comprise one or more machines, is shown as including processing circuitry 102, memory 104, communications circuitry 106 (which is communicatively coupled to database 108 and network 110), user interface 112 (which may receive and/or provide information from/to user 114), and model executor 116.

Processing circuitry 102 may include means for implementing various functionality, including circuitry comprising microprocessors, coprocessors, controllers, special-purpose integrated circuits such as, for example, ASICs (application specific integrated circuits), FPGAs (field programmable gate arrays), hardware accelerators, and/or any other type of hardware. According to some example embodiments, processing circuitry 102 may include processor 118, which may be representative of a plurality of processors and/or other types of circuitry operating in concert. For example, processor 118 may, but need not, include one or more accompanying digital signal processors. In some example embodiments, processor 118 is configured to execute instructions stored in storage device 120 or instructions otherwise accessible to the processor 118. Whether configured as hardware or via code stored on a computer-readable storage medium (such as storage device 120, memory 104 and/or database 108), or by a combination thereof, processor 118 may be an entity capable of performing actions according to embodiments of the present invention while configured accordingly. Thus, in example embodiments where processor 118 is embodied as an ASIC, FPGA, or the like, processor 118 is specifically configured hardware for conducting the actions, some examples of which are described herein. Alternatively or additionally, in example embodiments where processor 118 is embodied as an executor of instructions stored on a computer-readable storage medium, the instructions specifically configure processor 118 to perform the algorithms and actions, some examples of which are described herein. In some example embodiments, processor 118 is a processor of a specific device (e.g., distribution system 102) configured for employing example embodiments of the present invention by further configuration of processor 118 via executed instructions for performing the algorithms and actions described herein.

Memory 104, database 108 and/or storage device 120 may comprise one or more computer-readable storage media, such as volatile and/or non-volatile memory. Memory 104, database 108 and/or storage device 120 may be contrasted with a computer-readable transmission medium, such as a propagating signal. In some example embodiments, memory 104, database 108 and/or storage device 120 comprises random access memory (“RAM”) including dynamic and/or static RAM, on-chip or off-chip cache memory, and/or the like. Further, memory 104, database 108 and/or storage device 120 may comprise non-volatile memory, which may be embedded and/or removable, and may comprise, for example, read-only memory, flash memory, one or more magnetic storage devices (e.g., hard disks, floppy disk drives, magnetic tape, etc.), optical disc drives and/or media, non-volatile random access memory (“NVRAM”), and/or the like. Memory 104, database 108 and/or storage device 120 may comprise a cache area for temporary storage of data. In some embodiments, as shown in FIG. 1, storage device 120 may be included within processing circuitry 102, memory 104 may be external to processing circuitry 102 but internal to computer system 100, and database 108 may be external to computer system 100.

Further, memory 104, database 108 and/or storage device 120 maybe configured to store information, data, applications, computer-readable program code instructions (such as the rules that form models discussed herein), or the like for enabling processor 118 to carry out various functions in accordance with example embodiments of the present invention described herein. For example, storage device 120 could be configured to buffer input data for processing by processor 118. Additionally, or alternatively, storage device 120 may be configured to store instructions for execution by processor 118. Memory 104, database 108 and/or storage device 120 may also be configured to store additional information such as, but not limited to, historical data for in connection with one or more models run by computer system 100.

Communications circuitry 106 may be configured to facilitate communications between processing circuitry 102 and various external devices, such as database 108, network 110 and/or any device connected to network 110. Like other components discussed herein, communications circuitry 106 may include any component, device and/or other means embodied in hardware, a computer program product, or a combination of hardware and a computer program product that is configured to receive and/or transmit data from/to a network and/or any other device and/or module in communication with distribution system 102. Processor 118 may also be configured to facilitate communications via communications circuitry 106 by, for example, controlling hardware included within the respective components. In this regard, communications circuitry 106 may comprise, for example, one or more antennas, a transmitter, a receiver, a transceiver and/or supporting hardware, comprising a processor for enabling communications with network 110.

Communications circuitry 106 may be configured to provide communications in accordance with any wired and/or wireless communication standard and/or communications technique. For example, communications circuitry 106 may be configured to communicate using techniques involving radio frequency (“RF”), infrared (“IrDA”) or any of a number of different wireless networking techniques, including WLAN techniques that are compliant with IEEE 802.11 (e.g., 802.11a, 802.11b, 802.11g, 802.11n, etc.), wireless local area network (“WLAN”) protocols, world interoperability for microwave access (“WiMAX”) techniques such as IEEE 802.16, and/or wireless personal area network (“WPAN”) techniques such as IEEE 802.15 (BlueTooth®), and/or the like.

User interface 112 may be in communication with processing circuitry 102 to receive user input parameter(s) from, for example, user 114. For example, user interface 112 may include hardware, software and/or firmware for a keyboard, mouse, track pad, multi-touch screen, microphone, camera, and/or any other input component with which user 114 may interact. The input parameters received by user interface 112 may include input parameters set by user 114. Some exemplary input parameters include field set-up, proportion odd-seed, length of run (e.g., years, months, days, and/or any other period of time), initial gene frequencies, fecundity, dynamic movement and dispersal data, heritability, toxicity, initial population density, sex ratio, male dispersal, and plant density. In some embodiments, additional or alternative input parameters may be provided by user 114 to computer system 100 for use in some models, such as for example, dose, resistance allele frequency, dominance/genotypic fitness, pest emergence phenology and daily oviposition rate curve.

In some embodiments, default parameters may be stored in a memory device (such as memory 104, database 108 and/or storage device 120). The default parameters may be used by computer system 100, in response to computer system 100 determining that user 114 has failed to provide one or more required input parameters.

User interface 112 may also be configured to present one or more outputs to user 114. For example, user interface 112 may include hardware, software and/or firmware for a display (e.g., a touch screen display), a speaker, and/or any other type of audible, visual, mechanical (including tactile) that can provide output indications to user 114. Upon executing a model, computer system 100 may produce various forms of outputs, such as for example, allele frequency by year (and/or any other time period), number of adult pests per plant, adult pests by genotype, adult pests by refuge-type, among other things.

Model executor 116 may include circuitry that can be configured to execute a model that utilizes the input parameters received from user 114 and/or a storage device to generate the outputs provided to user 114. Model executor 116 may include circuitry (e.g., processing circuitry, memory, etc.), computer readable code, and/or a combination thereof. In some embodiments, model executor 116 may interface with processing circuitry 102. Additionally or alternatively, model executor 116 may be partially or wholly included in processing circuitry 102.

In some embodiments, model executor 116 may process one or more rules that comprise a model. For example, the rules and/or model executed by model executor 116 may be for general coleopteran population genetics for multiple genes with multiple alleles with at least one allele conferring some level of tolerance to insecticidal crop traits. Some models discussed herein may be configured to predict both population densities and allele frequencies for each life stage.

Examples of coleopteran pests include, without limitation, the western corn rootworm (“WCR,” Diabrotica virgifera virgifera LeConte), the northern corn rootworm (“NCR;” Diabrotica barberi Smith and Lawrence), the Mexican corn rootworm (“MCR,” Diabrotica virgifera zeae Krysan and Smith), the southern corn rootworm (“SCR,” Diabrotica undecimpunctata howardi), and the Colorado potato beetle (“CPB,” Leptinotarsa decemlineata).

Some computer-implemented models discussed herein can be configured to model examples of coleopteran with, for example, a focus on WCR. While WCR-focused models and/or other types of models are discussed herein, model executor 116 can be configured to execute rules associated with any type of insect and/or other type of living organism(s) (including those that promote growth as well as or instead of those that inhibit growth of some plants). The various organisms that may have one or more associated rules may each be associated with, e.g., different life stages that are considered by the various models executed by model executor 116.

The various computer rules that represent an organism's life stages and are executed by model executor 116 may be constructed manually, automatically, and/or a combination thereof. For example, user 114 may enter them into computer system 100. As another example, computer system 100 may be configured to receive data inputs (e.g., from sensors that are configured to detect the dynamic movement of a pest) via network 110 and create rules therefrom. For example, the dynamic movement may include the direction, distance, rate and/or other potentially non-uniform characteristics as well as any uniform characteristics of a pest's movement. In this regard, user 114 and/or computer system 100 may construct rules based on empirical testing, scientific experimentation, theory, nonscientific observations, among other things.

For example, a computer-implemented model may include rules that define larval movement among plants, between refuge and transgenics, and from alternate hosts. The larval movement may be modeled dynamically and/or uniformly. The model may allow for pest-specific numbers of generations a year. For example, a first pest may be associated with a first number of generations (e.g., one, two, or more) a year and a second pest may be associated with a second number of generations (which may be the same or different as the first number of generates, e.g., two, three, or more) per year. Like other rules, the model's rules governing the number of pest-specific generations per year may be specific to geographic location and/or climate.

In some embodiments, the model executed by model executor 116 may be configured to include rules for two major genes and two alleles per gene. Different models may include rules that include more or fewer genes and/or alleles per gene. For example, a model's rule(s) can allow an allele dominance to be specified (e.g., by user 114) from 0 to 1 for each gene.

The model executed by model executor 116 can also be configured to include one or more rules that correspond with one or more host plants, such as corn, soybean, and/or other crops of interest (or alternate host refuges). For example, the model can include rules that define the mortality from aerial applications, seed treatment and/or other chemical pesticides.

A further example of pest resistance traits includes lepidopteran pest resistance traits. The model also can be configured to include rules comprised of an algorithm for a general lepidopteran population genetics for one or more genes with one or more alleles with at least one allele conferring some level of tolerance to insecticidal crop traits. The model may be used to predict and output to user 114, for example, population densities and/or allele frequencies for each life stage of one or more pests in a specific geographic area dominated by one or more plants.

Examples of lepidopteran pests include, without limitation, the European corn borer (“ECB”) (Order Lepidoptera: Family Crambidae), the southwestern corn borer (“SWCB”) (Order Lepidoptera: Family Crambidae), the corn earworm (“CEW”) (Order Lepidoptera: Family Noctuidae), the fall armyworm (“FAW”) (Order Lepidoptera: Family Noctuidae), the velvetbean caterpillar (“VBC”) (Order Lepidoptera: Family Noctuidae), the soybean looper (“SBL”) (Order Lepidoptera: Family Noctuidae), the western bean cutworm (“WBCW”) (Order Lepidoptera: Family Noctuidae), the black cutworm (“BCW”) (Order Lepidoptera: Family Noctuidae), and the sugar cane borer (“SCB”) (Order Lepidoptera: Family Crambidae).

In some embodiments, the model executed by model executor 116 can be configured to include one or more rules that allow for modeling examples of lepidopteran with a focus on, e.g., the ECB and/or SWCB. Further to the discussion above, the model can accommodate one or more, and up to all, life stages. In some embodiments, one or more rules may be included in the model, which are associated with each life phase of each pest and/or other type of organism able to be modeled. For example, the model can be configured to forecast expected larval movement among plants, between refuge and transgenics, and from alternate hosts.

In some embodiments, the model executed by model executor 116 can be configured to allow, for example, two generations a year for most cases and three generations in other cases (such as for CEW) and can be adapted as necessary for different pests. The model can include rules that enable model executor 116 to consider two major genes and two alleles per gene, although the model configuration may be adjusted to accommodate more or fewer. The model can be configured for an allele dominance to be specified from, for example, 0 to 1 for each gene. The model can also be configured to include rules for one or more host plants, such as corn, soybean, and/or other crop(s) of interest (and/or alternate host refuges). Model executor 116 can be configured to calculate expected mortality from aerial applications, seed treatment, and/or other chemical pesticides, among other things.

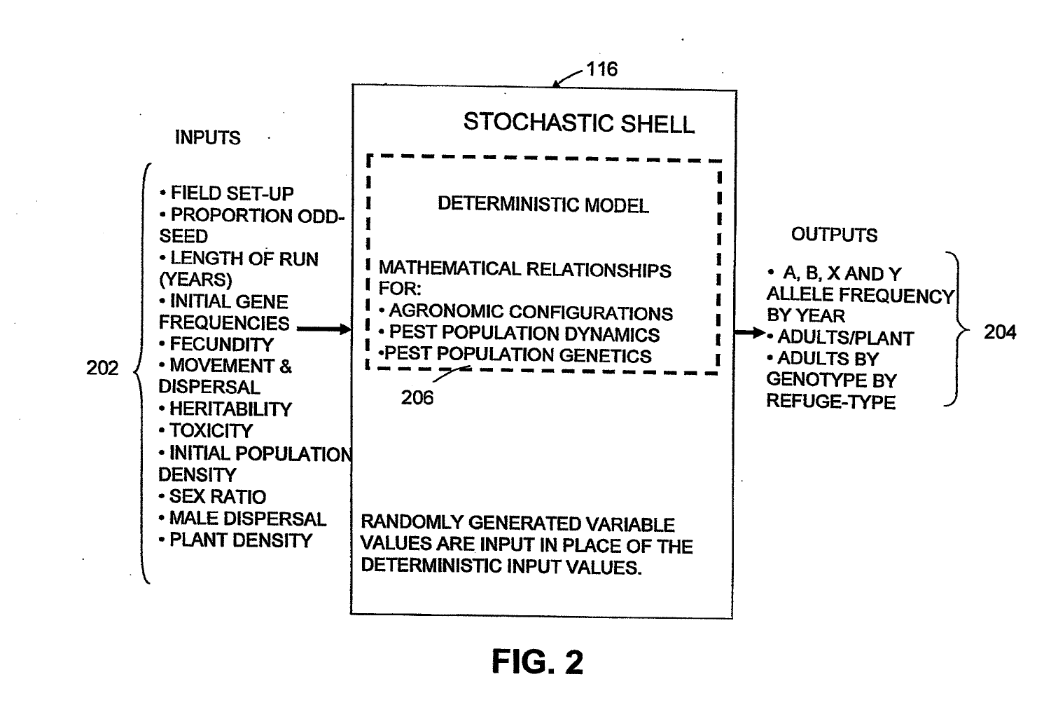

FIG. 2 is a block diagram showing exemplary components of model executor 116. As shown in FIG. 2, input parameters 202 and outputs 204 are provided into and out from model executor 116. In some embodiments, inputs 202 can be received from processing circuitry 102 and/or any other component discussed herein. Model 206 is shown as including a deterministic model and a stochastic shell. The deterministic model may provide rules comprised of mathematical relationships for, e.g., agronomic configurations, pest population dynamics and pest population genetics. It is contemplated that in some embodiments only the results of the deterministic model may be of interest. In some embodiments, the stochastic model may be implemented by randomly generating variable values and using such values in place of the deterministic input values.

It is to be understood that the model 206 may be implemented using any number of circuitry hardware components, applications and/or computer languages. For example, the deterministic model may be implemented using Microsoft's Excel® and Visual Basic for Applications with the stochastic shell aspect of the model being implemented using, for example, Microsoft's Excel® and Oracle's Crystal Ball®.

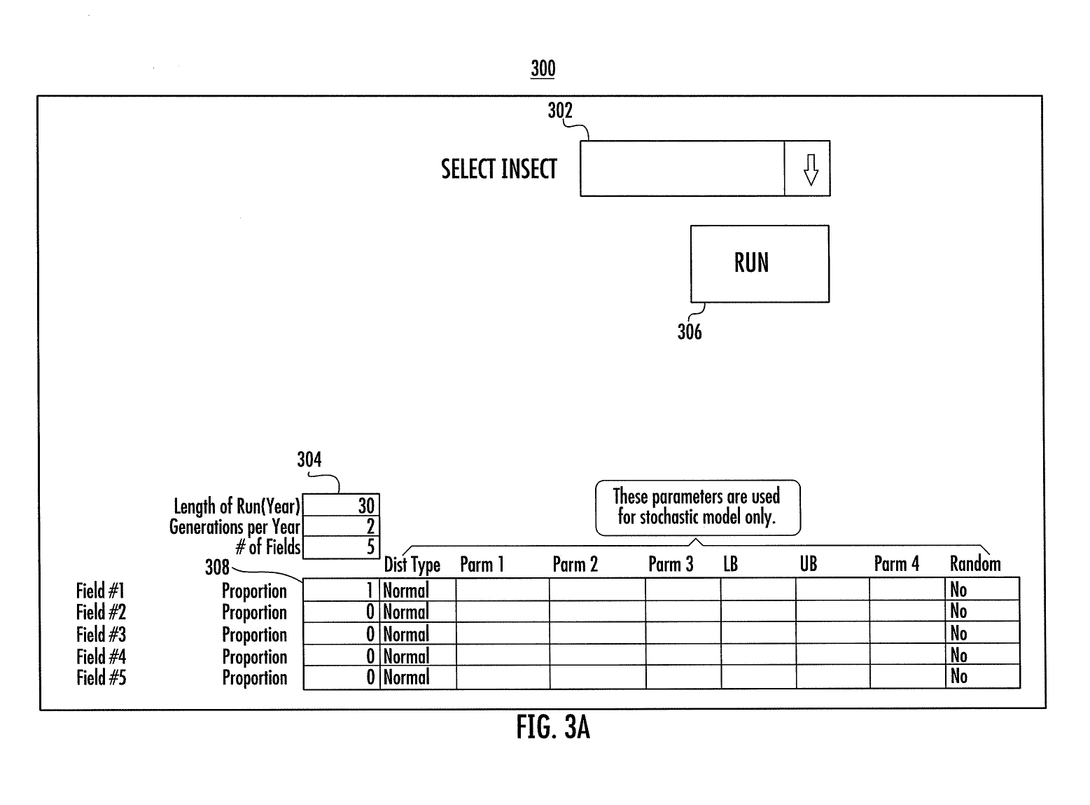

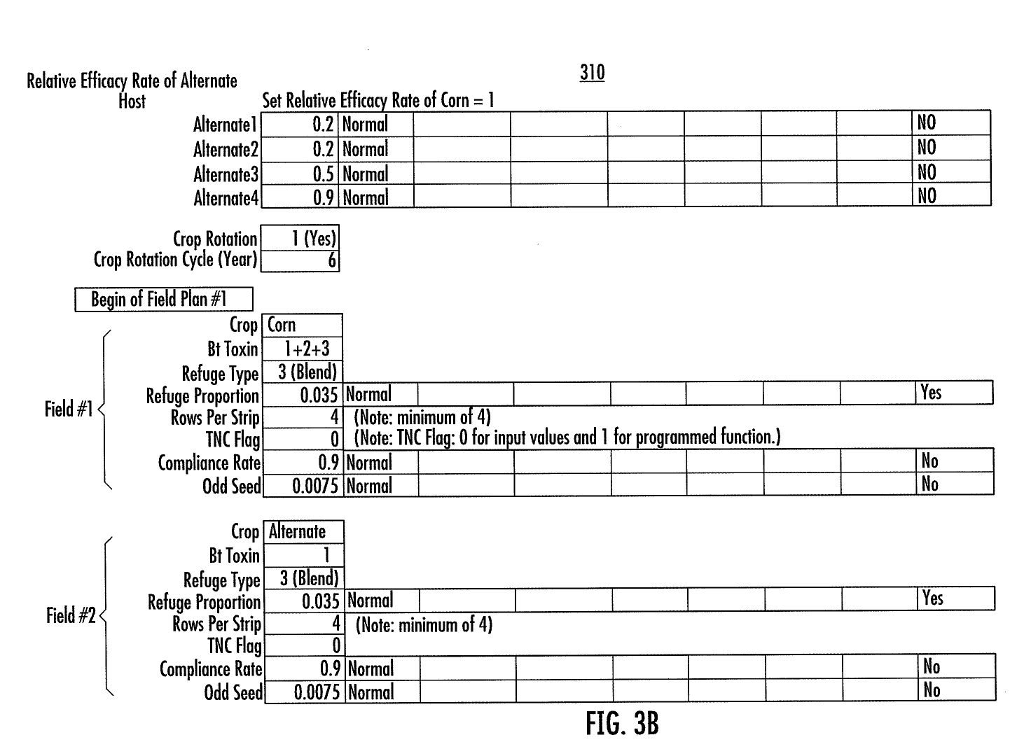

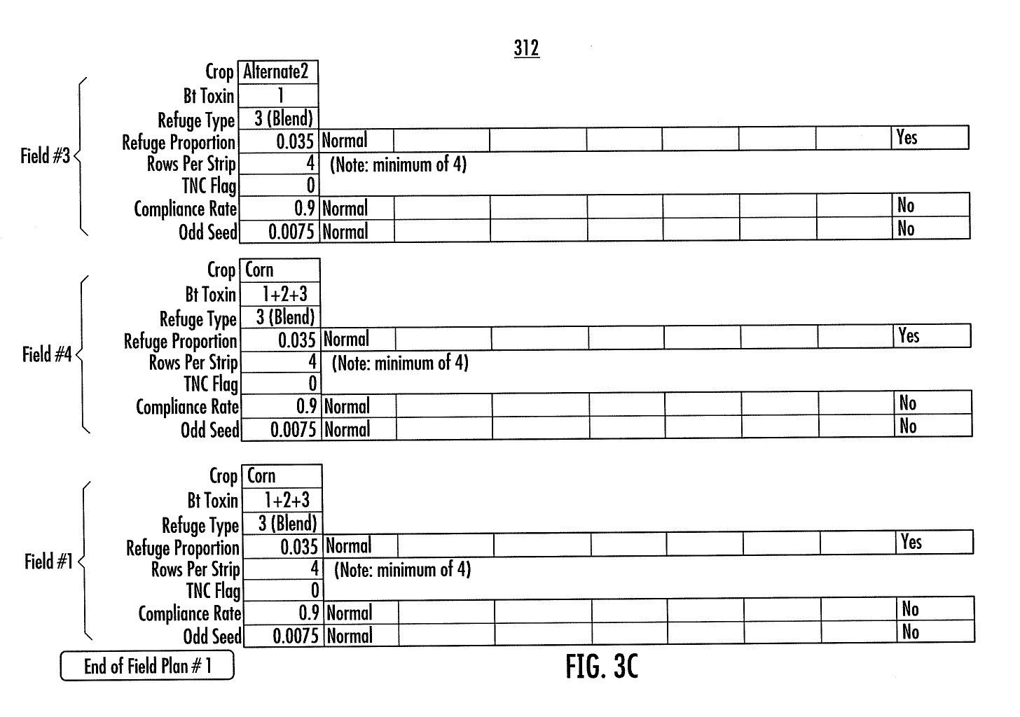

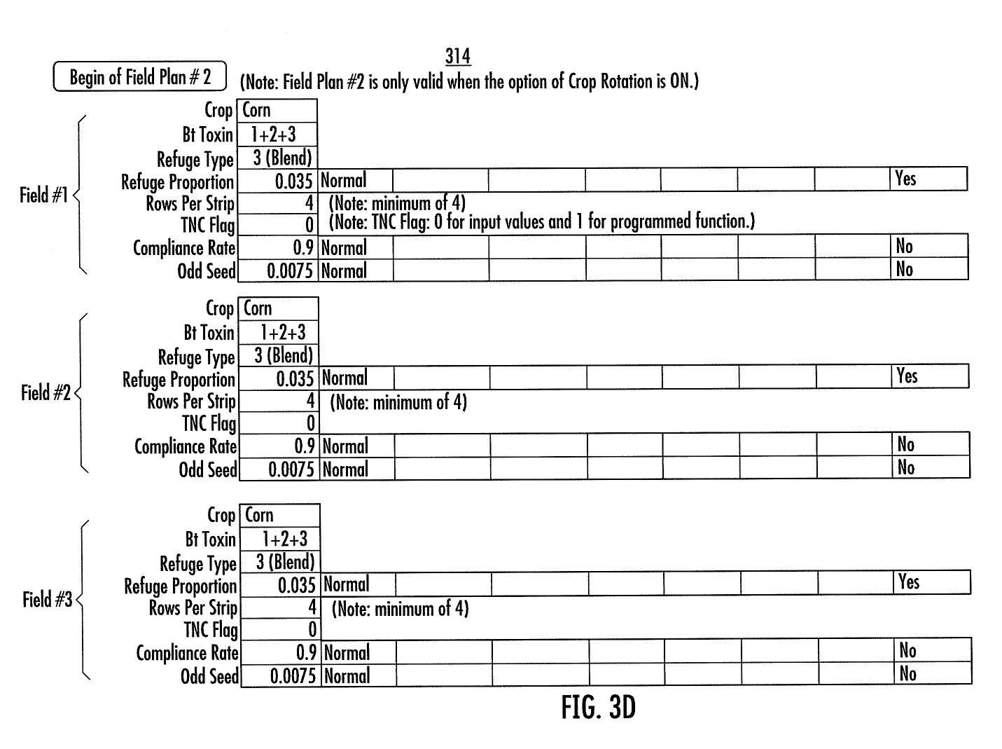

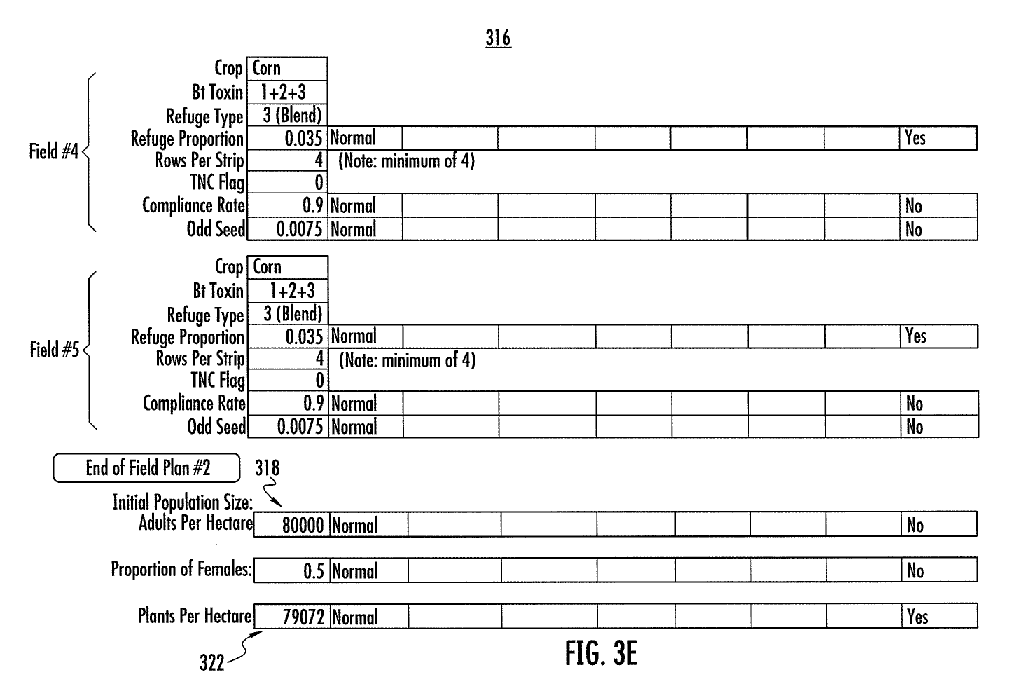

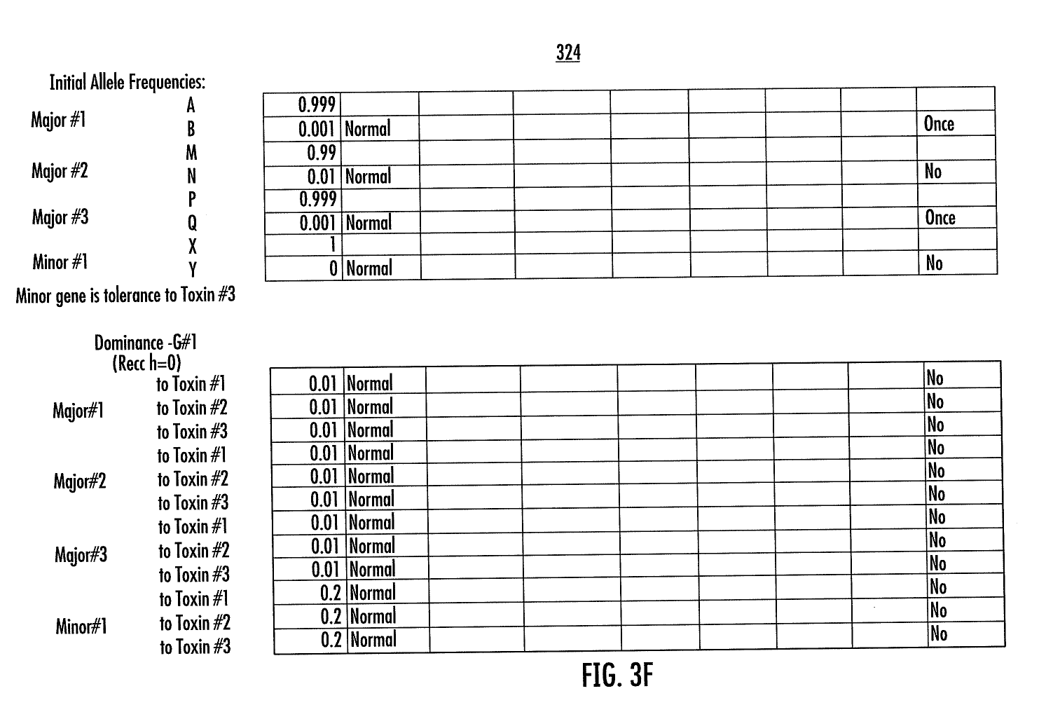

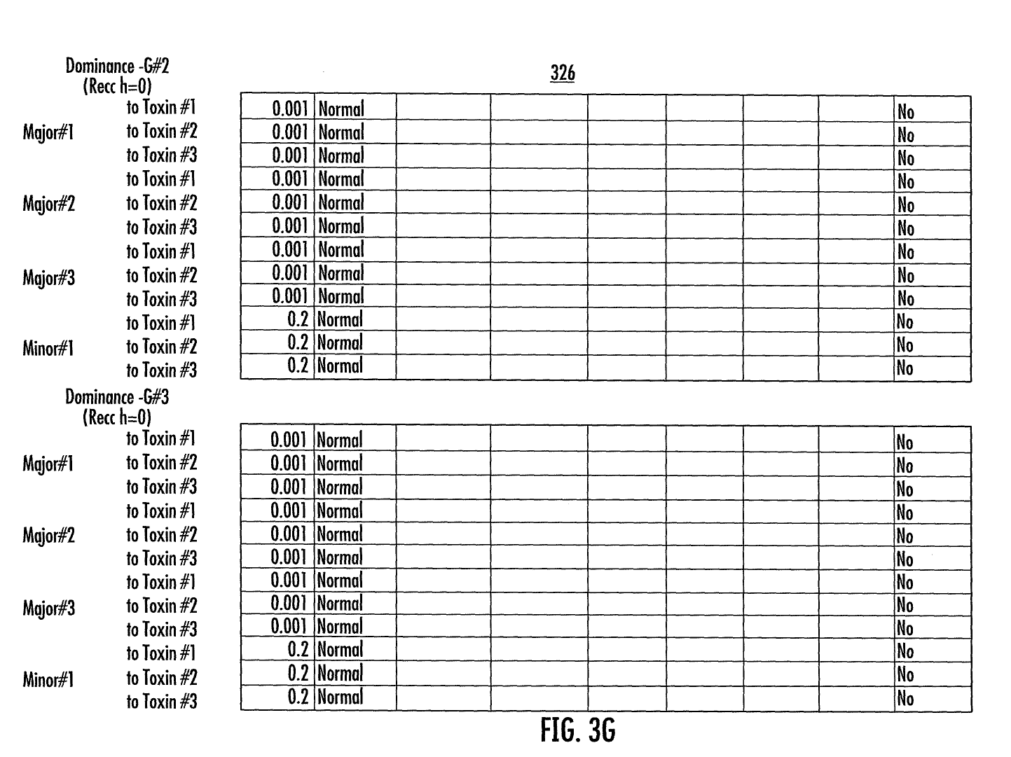

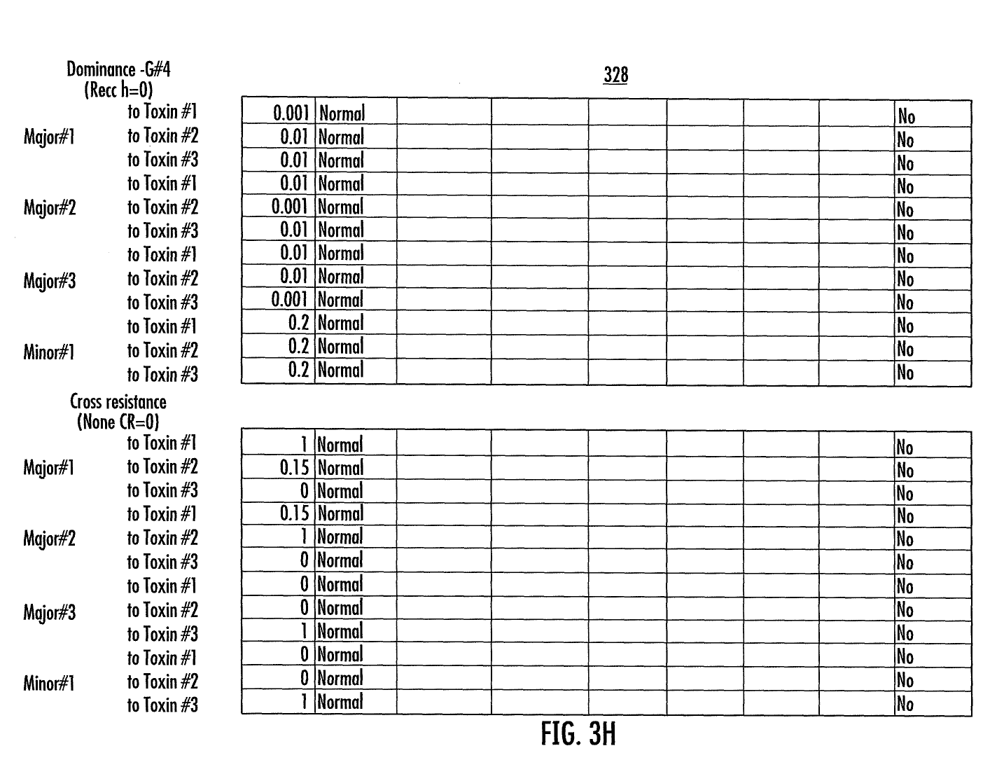

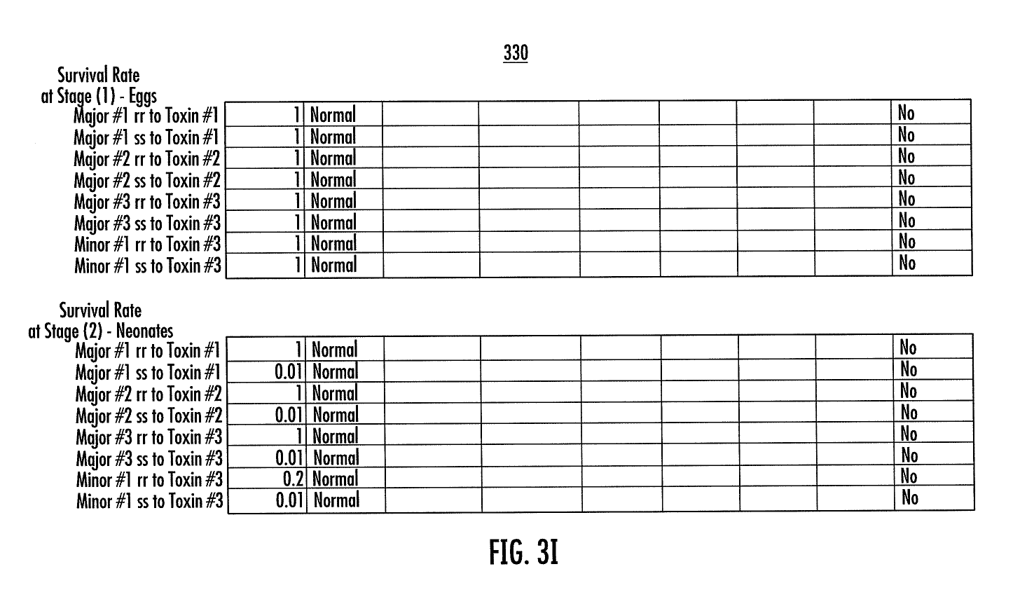

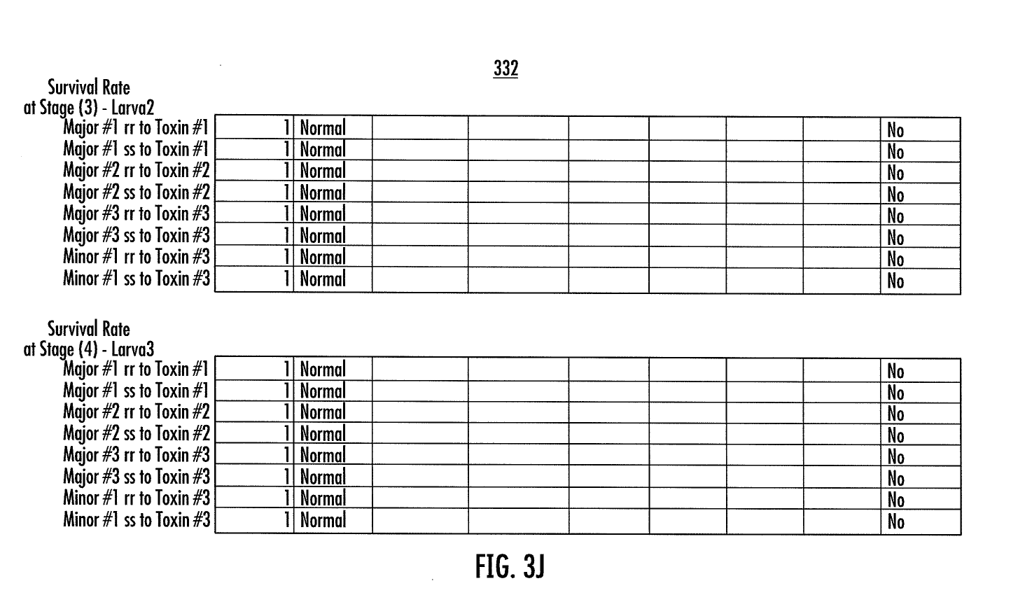

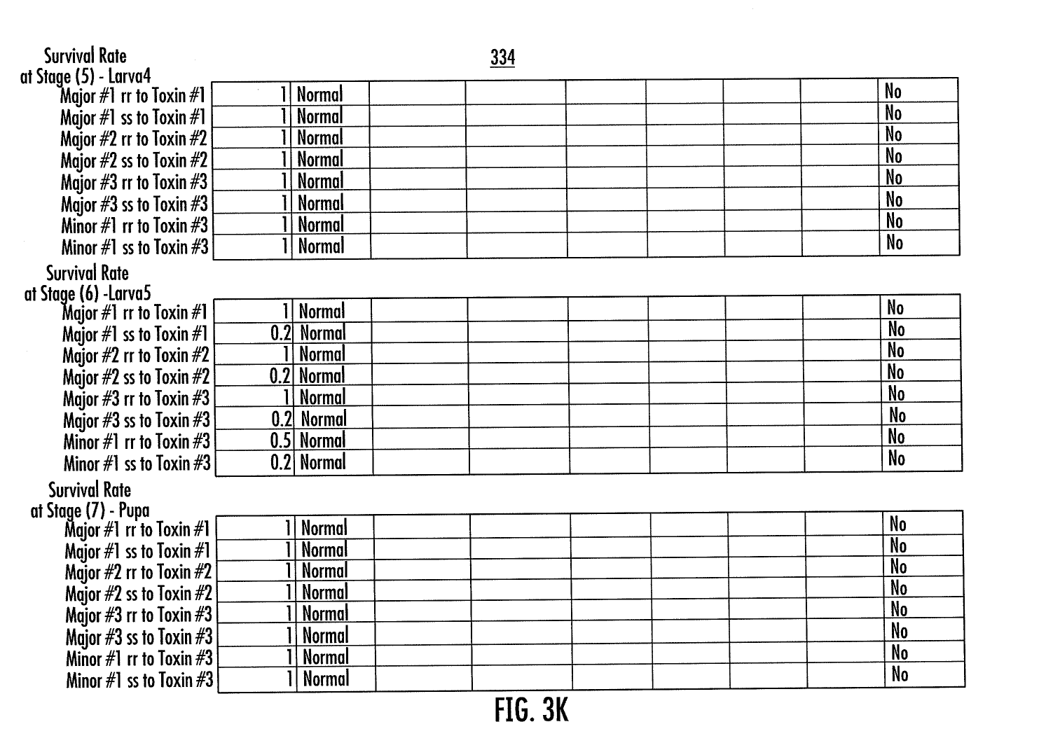

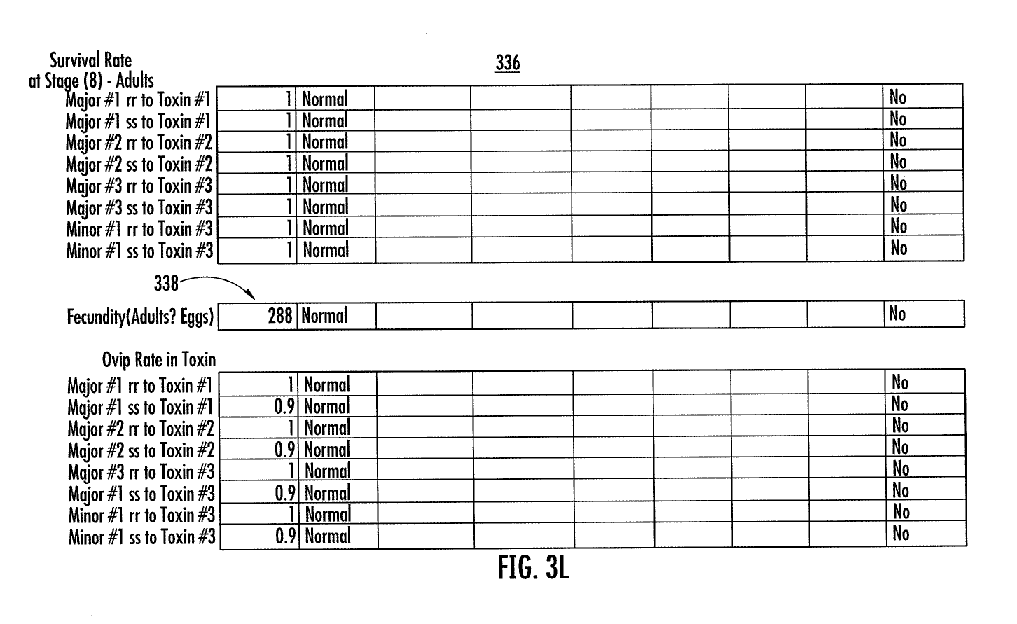

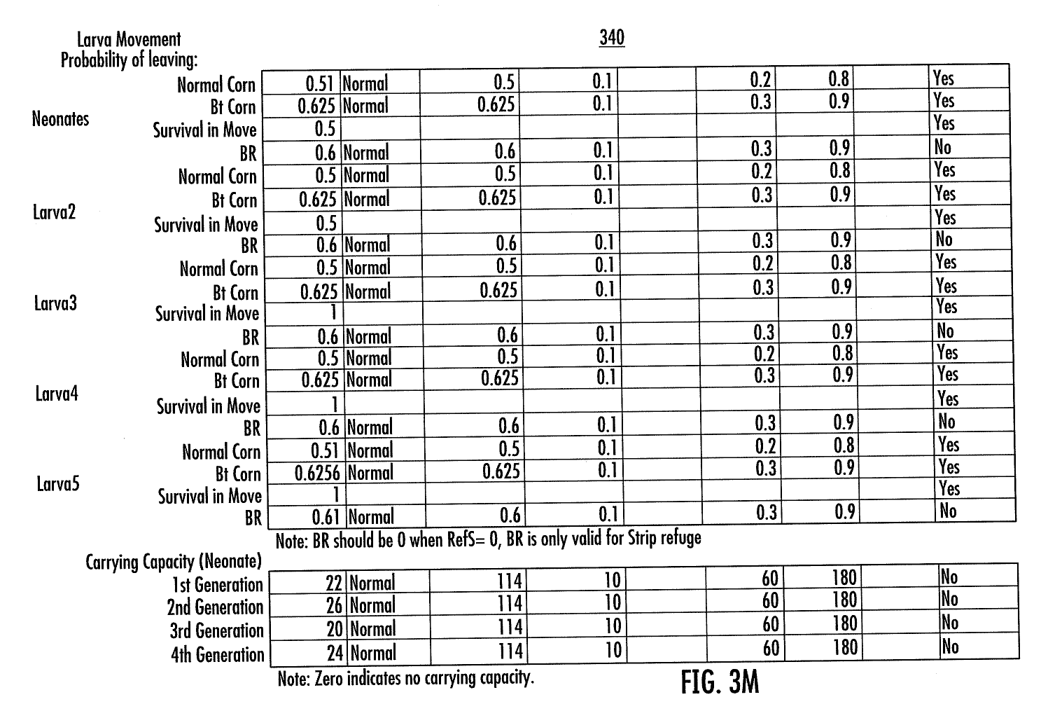

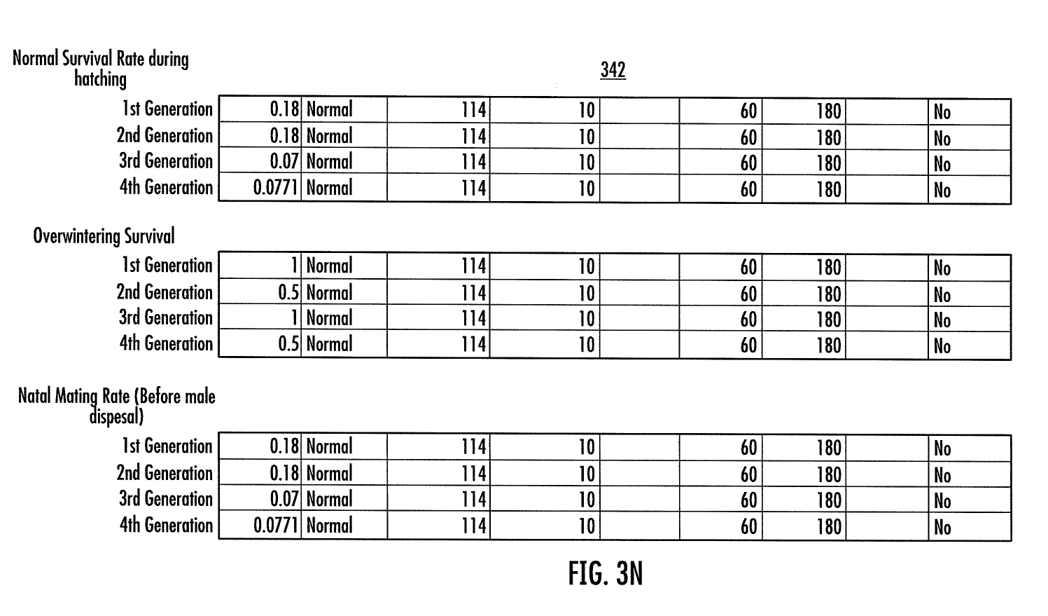

FIGS. 3A-3N show how some embodiments of computer system 100 and/or any other modeling system may receive various input parameters. FIG. 3A, for example, shows display 300, which may be outputted by user interface 112 and include various prompts and other elements user 114 may use to enter input parameters. For example, pull down menu 302 may allow the user to indicate a desire of one or more a particular types of insect and/or other organism to be the focus of the model. As shown by input entry boxes 304, the length of the simulation run time, in years, may be specified. In some embodiments, the number of generations may be automatically populated in response to an insect being selected in pull down menu 302 and run button 306 being selected by user 114. In other embodiments, the number of generations may be manually entered (e.g., typed) by user 114 into input entry boxes 304. User 114 may also specify the number of fields (including area used to grow crops and/or where insects may move and/or breed) and/or other areas (e.g., bodies of water, rocky areas, etc.) in input entry boxes 304. In some embodiments, the number of fields and/or other areas may be automatically determined based on default parameters stored by system 100 and/or be populated by any other means. Boxes 308 may be used to set and/or display additional input parameters for each of fields and/or other types of areas being considered by the stochastic model(s) being executed by computer system 100.

FIG. 3B shows display 310, which may be presented by computer system 100. User 114 may use display 310 to specify and/or observe the relative efficiency rate of alternate hosts for one or more of the fields and/or other areas identified in display 300. In addition, display 310 may be used to input whether or not crop rotation is used along with and/or instead of the crop rotation cycle.

Next, in some embodiments, user 114 can provide one or more inputs that specify or otherwise define the first field plan. Display 310 of FIG. 3B and display 312 of FIG. 3C show the first field plan. Display 314 of FIG. 3D and display 316 of FIG. 3E show a second field plan. For each field plan shown in displays 310, 312, 314 and 316, the type of crop for each field is specified by user 114, computer system 100, and/or by any other system (such as, e.g., an external system that interfaces with computer system 100 via network 110). For example, the Bt toxin used can be specified as well as the refuge type. The refuge type may be set as a block refuge, strip refuge, blended refuge and/or any other type of refuge. The refuge proportion can also specified (manually, automatically, and/or otherwise) as well as, for example, the number of rows per strip, a compliance rate, and an odd seed rate or proportion of odd seeds.

As shown in FIG. 3E, one or more aspects of the initial population size can be specified (manually, automatically, and/or otherwise) at boxes 318, 320 and/or 322. For example, the adults per hectare may be defined by boxes 318, the proportion of females may be defined by boxes 320, and plants per hectare may be defined by boxes 322.

FIG. 3F shows display 324, which includes exemplary initial allele frequencies for one or more (e.g., three) major genes and at least one minor gene. The minor gene may, for example, confer a low or other level of larval tolerance to maize 59122 and/or one or more specific toxins. The minor gene may also correspond with one of the major genes. In some embodiments, the model can be configured to assess a major resistance gene separately from a minor resistance gene to avoid uncertainties around the interaction of the two genes. For example, the model may be configured to evaluate two genes each linked to a different toxin, allowing, for example, a pyramided CRW product to be evaluated.

The tolerance to each toxin is also shown in display 324. The tolerance information, like any other information presented in the displays discussed herein, may be retrieved from, for example, a remote device (via, e.g., network 110), memory 104, database 108 and/or storage device 120, and/or user 114 may enter information presented in the displays generated by systems in accordance with some embodiments discussed herein.

FIGS. 3G and 3H respectively show displays 326 and 328. Displays 324, 326 and 328 including exemplary dominance for each gene. Display 328 also shows an example of how cross-resistance may be presented to user 114 by computer system 100.

FIG. 3I shows display 330, which includes exemplary survival rates for a first stage of an organism (e.g., eggs) and a second stage of the organism (e.g., neonates). FIG. 3J shows display 332, which includes survival rates for a third stage of the organism (e.g., larvae 2) and a fourth stage of the organism (e.g., larvae 3). FIG. 3K shows display 330, which includes survival rates for a fifth stage of the organism (e.g., larvae 4), a sixth stage of the organism (e.g., larvae 5), and a seventh stage of the organism (e.g., pupa). In some embodiments, such as if other types of organisms are being modeled, one or more of the displays discussed herein may be omitted (such as when, e.g., an organism has less stages of development) and/or additional organism-specific displays (not shown) may be generated and presented (such as when, e.g., an organism has different stages of development and/or there is other types of parameters that should be considered by computer system 100 when modeling the organism).

FIG. 3L shows display 336, which includes survival rates for an eighth stage of the organism (e.g., adult). Also in FIG. 3L, fecundity can be defined at input boxes 338. The oviposit rate in toxin may also be entered and/or presented as shown in display 336.

FIG. 3M shows display 340, which is an example of how larval movement can be inputted by and/or presented to user 114 in accordance with some embodiments discussed herein. The probability of movement for each stage of larva development may be specified as shown in display 340. For example, the probability of movement may be specified for a non-Bt crop, a Bt crop, a Bt crop with pesticidal treatment, and/or other permutations. Additionally or alternatively, a probability of survival in a move between crops can be provided. Also in display 340, carrying capacity may be specified for each generation.

In FIG. 3N shows display 342, which may provide the normal survival rate during hatching for each generation. Also, display 342 can present the overwintering survival for each generation. Natal mating rate can also specified as shown in display 342.

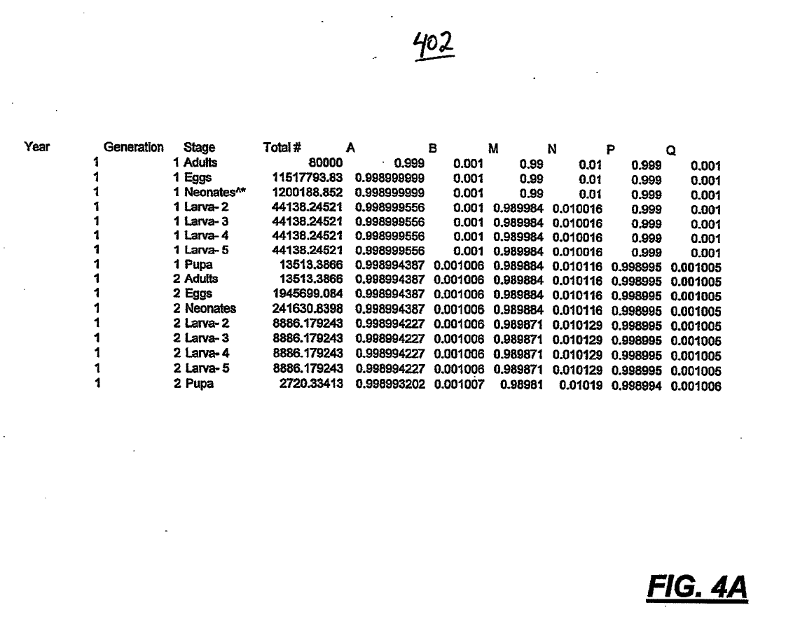

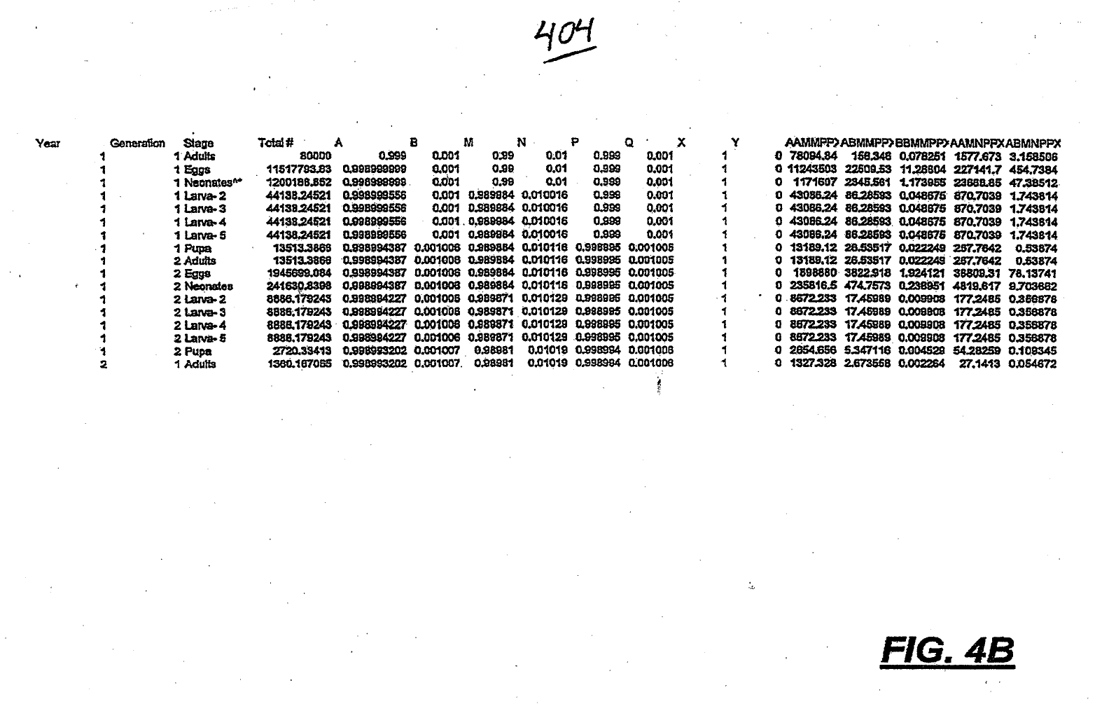

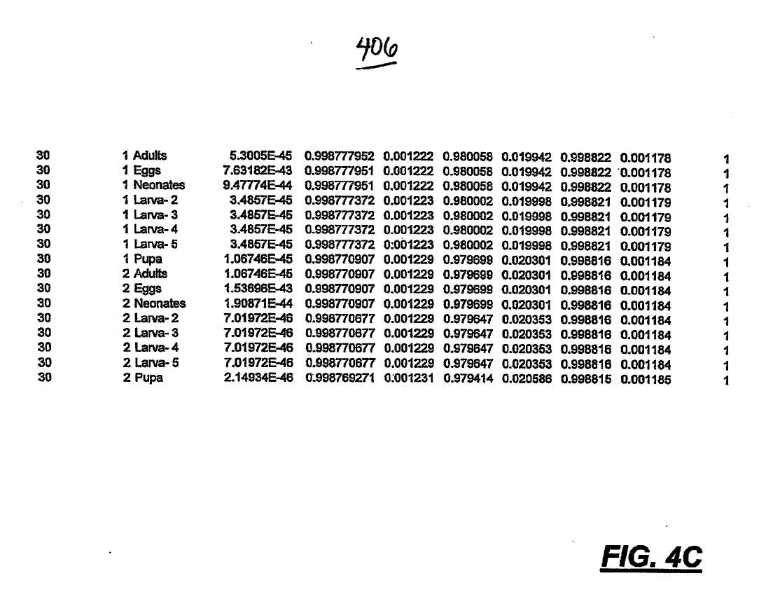

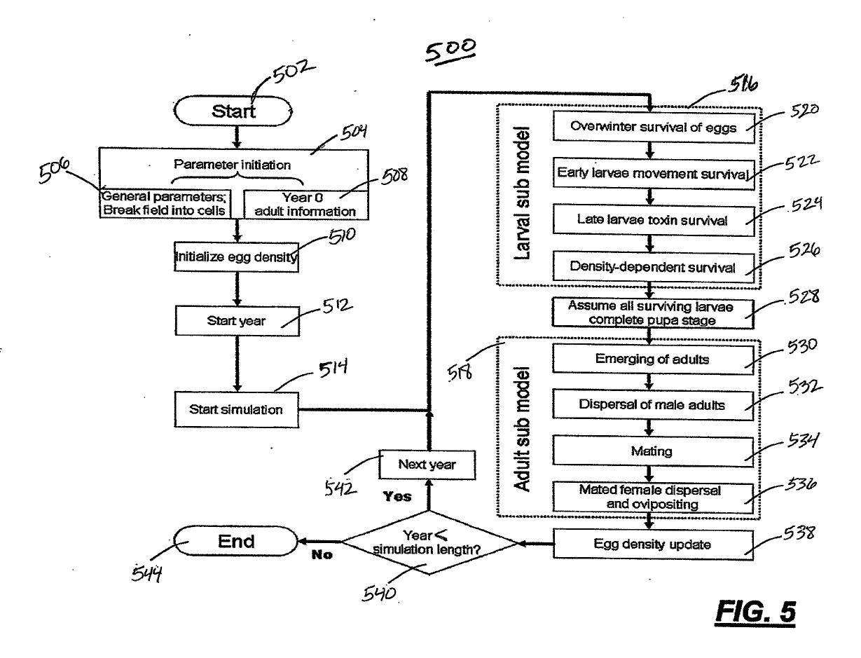

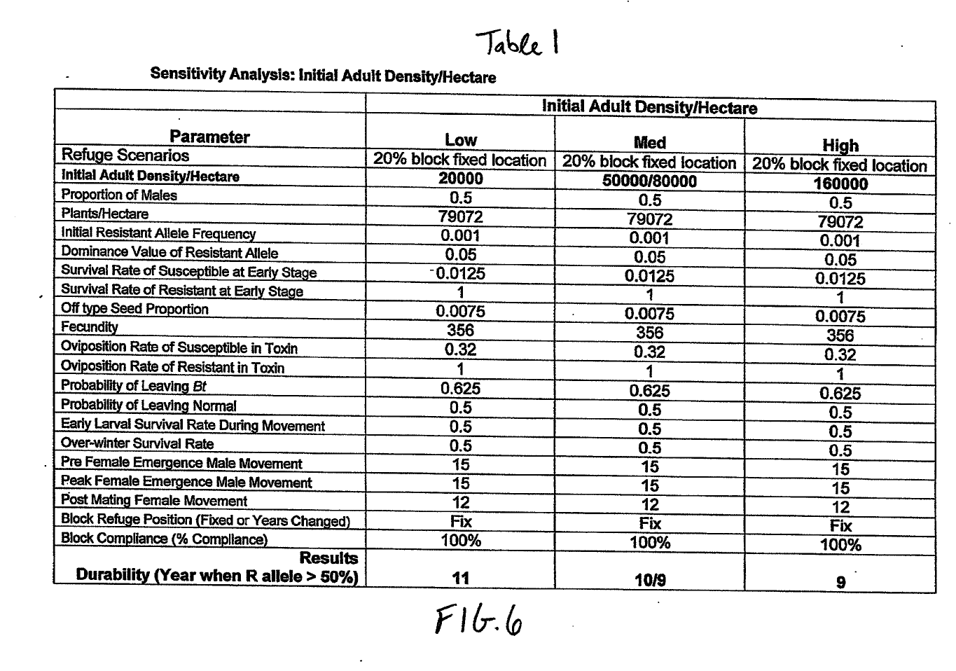

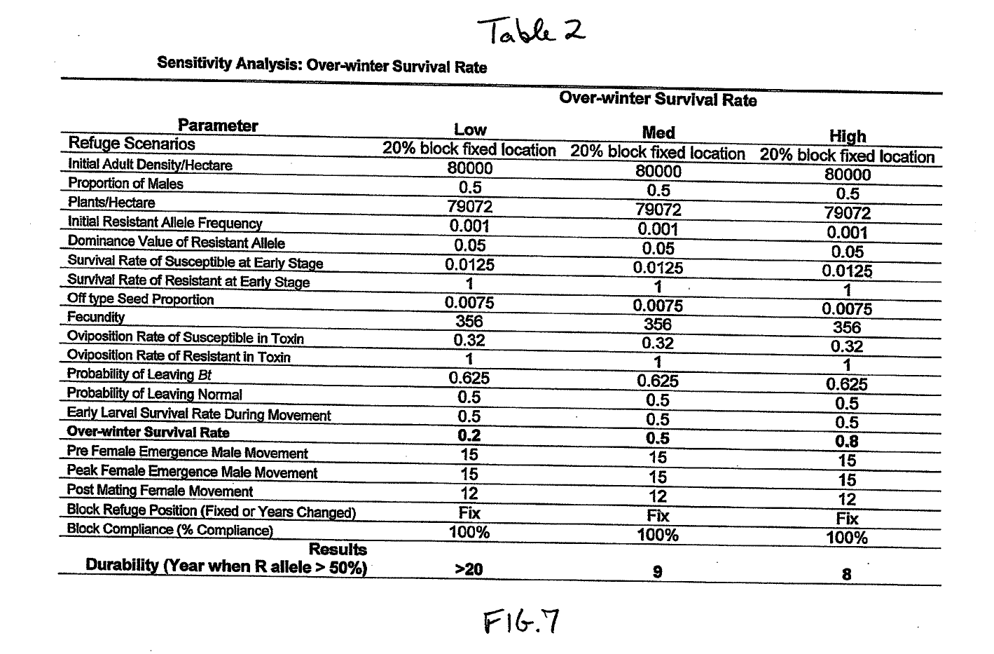

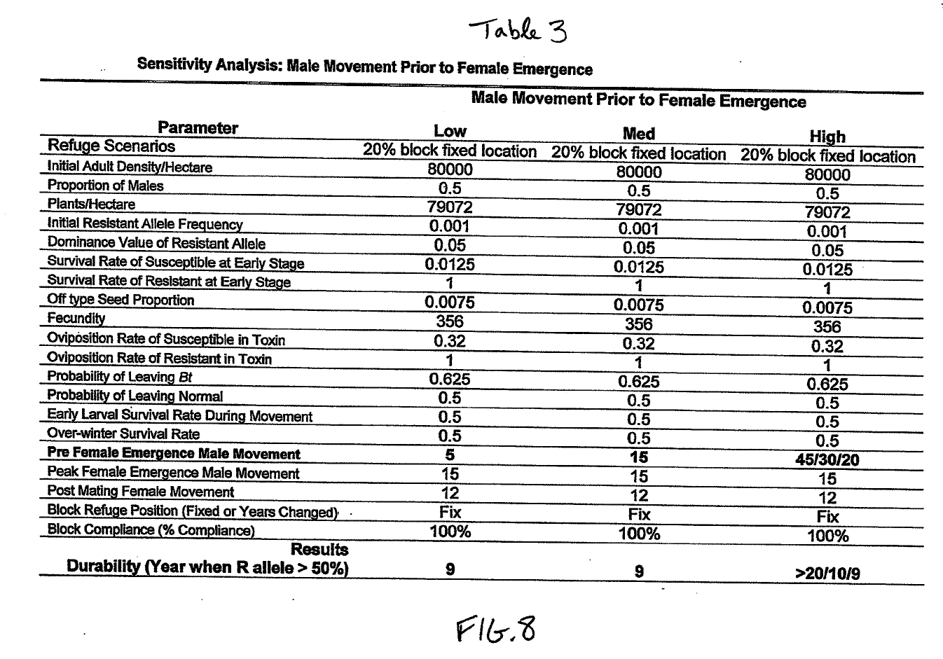

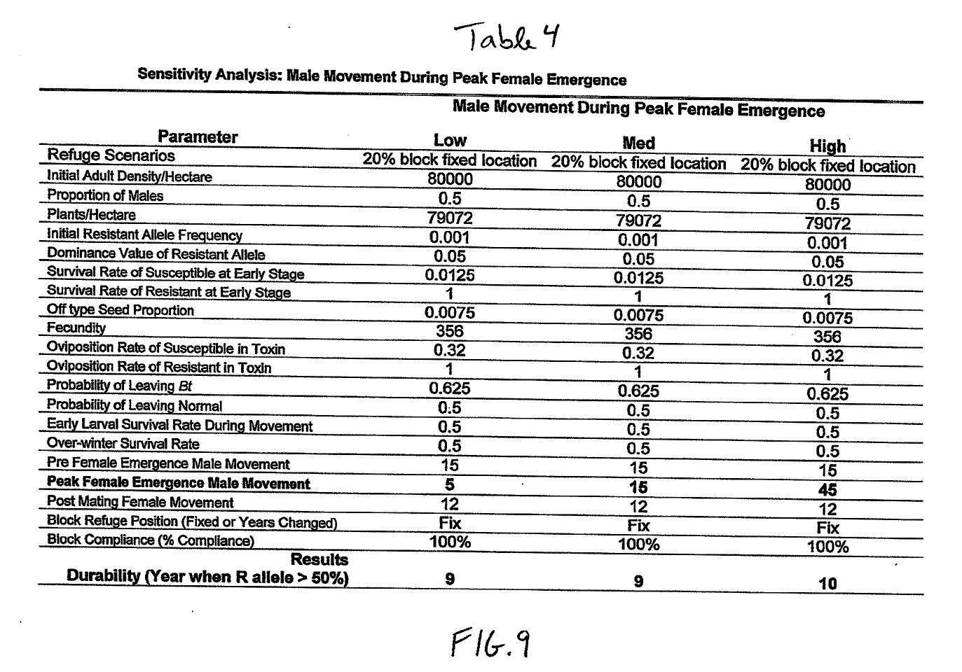

FIG. 4A through 4C respectively show displays 344, 346 and 348, which include examples of modeling outputs generated by computer system 100, may be presented to user 114. In FIG. 4A, for example, display 344 includes allele frequencies for each stage of each generation within each year. FIG. 4B shows display 346, which includes additional allele frequencies. FIG. 4C shows display 348, which includes allele frequencies with year 30. More or fewer output displays may be provided by some embodiments, having the same types and/or different information.

The model may be used to output the number of genotypes (81 total for 4 genes) in all life stages of each generation and related allele frequencies. The output may be tailored to address specific questions or analyses. What is shown is merely representative.

FIG. 5 shows a flow diagram in accordance with some exemplary methods, computer program products and/or systems discussed herein, including those discussed in reference to in FIG. 1 through FIG. 4C. It will be understood that each action, step and/or other types of functions shown in FIG. 5, and/or combinations of functions in FIG. 5, can be implemented by various means. Means for implementing the functions of FIG. 5, combinations of the actions in FIG. 5, and/or other functionality of example embodiments of the present invention described herein may include hardware, and/or a computer program product including a computer-readable storage medium (as opposed to or in addition to a computer-readable transmission medium) having one or more computer program code instructions, program instructions, or executable computer-readable program code instructions stored therein. In this regard, program code instructions may be stored on a storage device of an example apparatus and executed by a processor, such as the processing and other types of circuitry discussed above. As will be appreciated, any such program code instructions may be loaded onto a computer or other programmable apparatus (e.g., processing circuitry 102, model executor 116, or the like) from a computer-readable storage medium (e.g., memory 104, database 108, storage device 120, or the like) to produce a particular machine, such that the particular machine becomes a means for implementing the functions specified in the diagram's actions shown in FIG. 5 discussed below.

These program code instructions may also be stored in a computer-readable storage medium that can direct a computer (such as computer system 100), a processor (such as the processing circuitry discussed above), or other programmable apparatus to function in a particular manner to thereby generate a particular article of manufacture. The article of manufacture becomes a means for implementing the functions specified in the diagram's actions. The program code instructions may be retrieved from a computer-readable storage medium and loaded into a computer, processor, or other programmable apparatus to configure the computer, processor, or other programmable apparatus to execute actions to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provides actions for implementing the functions specified in the diagrams' actions.

In this regard, FIG. 5 shows an exemplary method which may be implemented by, e.g., model executor 116 and/or other components of computer system 100 during the modeling process., As shown in FIG. 5, process 500 starts at 502. At 504, parameters can be initialized. The parameter initiation may include, for example, initializing general parameters and the breaking of a crop field into individual cells at 506. The parameter initiation at 504 may additionally or alternatively include initializing the first year (e.g., year 0) adult information at 508. In some embodiments, computer system 100 may execute 504 by providing, for example, an input display (such as those discussed above) that prompt user 114 to enter the inputs desired by computer system 100.

At 510, egg density is initialized. At 512, the first year can be started and at 514 computer system 100 can start the simulation of the model for the first year. The model process 500 can be divided into one or more sub-processes of sub-models that may be executed within computer system 100. For example, process 500 may include larval sub model process 516 and an adult sub model 518. In the larval sub model 516, at 520, overwinter survival of eggs can be determined and factored into the model. At 522, early larvae movement survival can be determined and factored into the model. At 524, late larvae toxin survival can be determined and factored into the model. At 526, density-dependent survival can be determined and factored into the model.

At 528, predetermined, one or more default assumptions can be made by computer system 100. For example, computer system 100 may be configured to assume that all surviving larvae complete the pupa stage.

Within the adult sub model 518 and at 530 the emerging of adults can be determined based upon the previous determinations. For example, the emerging of the adults may be dependent on the determination at 526 as to how many larvae have survived.

At 532, dispersal of adults can be determined based upon the adult's movement through the field. As mentioned herein, the adult's movement and dispersal may be calculated at 532 based on the size and shape of the field, the refuge area, and/or other variables user 114 may have inputted into computer system 100.

At 534, mating can be determined and factored into the model. At 536, mated female dispersal and ovipositing is determined. Because males may mate with multiple females, the male dispersal may be omitted from the model in accordance with some embodiments.

At 538, the circuitry of computer system 100 can be configured to calculate an egg density update. At 540, a determination can be made as to whether the current year is less than the simulation length. If it is, then at 542, the current year is increased to the next year and the simulation continues. If not, then at 544 the simulation model of process 500 ends.

In consideration of the methodology previously described, representing various embodiments of the present invention, the example presented below illustrates an exemplary application of the methodology discussed in connection with process 500. One skilled in the art will appreciate that this example, as well as other examples presented herein, are not intended to be limiting in any manner with respect to the applicability of the principles addressed herein.

Example Application of the Simulation Model for CRW Comparing Blended Refuge with Adjacent Block Refuge

Different refuge deployment options which compare the effect on the durability of maize containing event DAS-59122-7 (“maize 59122”) are disclosed. A range of input parameters, including conservative estimates, was used to model best-, worst- and realistic scenarios.

Simulation results can be generated and presented for several CRW refuge deployment strategies, including: maize 59122 fields with no refuge (5 years durability); maize 59122 fields with a 20% block refuge planted in the same location each year with 100% compliance (9 years durability); maize 59122 fields with a 20% block refuge planted in different locations each year and with only 70% compliance (7 years durability); and maize 59122 fields planted with a 5% blended refuge (10 years durability).

In addition, some exemplary models can also be configured to examine the durability of maize 59122 when block refuges are used for a fixed time period (e.g., four years) prior to implementation of a blended refuge. As indicated in some exemplary scenarios that can be modeled, implementing a blended CRW refuge may maintain and/or extend the durability of maize 59122 compared to continuing with a block refuge.

For example, a simulation model was developed and tested that took into account adult western corn rootworm (“WCR,” Diabrotica virgifera virgifera LeConte) dynamic movement and the probability of mating between CRW males emerging from refuge maize with CRW females emerging from Bt maize. The model also considers durability across multiple fields when planted in a landscape and/or mosaic of currently registered CRW products containing event DAS-59122-7 (Cry34/35 or maize 59122). Conservative parameter estimates for dose, resistance allele frequency, and dominance/genotypic fitness can be used to model multiple scenarios. The exemplary model can incorporate parameters that reflect realistic pre-mating dispersal, mating, and oviposition as well as, in some embodiments, providing a sensitivity analysis of adult CRW dynamic movement and any effect the movement may have on CRW durability. As discussed herein, this exemplary model demonstrated that a 5% blended refuge disperses refuge beetles throughout the field, enabling random mating that past rootworm models falsely assumed block refuges would provide. The blended refuge provides the advantage that susceptible CRW males emerging from refuge plants will be within easy range, approximately 3.6 meters, of any female beetle that emerges from maize 59122 plants anywhere in the field.

Further the exemplary model was able to assess a major resistance gene separately from a minor resistance gene to avoid uncertainties around the interaction of the two genes. The present model was configured to evaluate two genes each linked to a different insecticidal protein, allowing a pyramided CRW product to be evaluated.

Although many of the biological parameters used in the exemplary model can be based on WCR data, modeling results can be applicable to all three CRW species on the maize 59122 label: WCR, northern corn rootworm (“NCR,” Diabrotica barberi Smith and Lawrence), and Mexican corn rootworm (“MCR,” Diabrotica virgifera zeae Krysan and Smith). NCR have been reported to move less (flying less and for shorter periods of time) than WCR (see, e.g., Naranjo, Comparative Flight Behavior of Diabrotica Virgifera Virgifera and Diabrotica Barberi in the Laboratory, Entomologia Experimentalis et Applicata, 55: 79-90 (1990)), and computer system 100 may take this difference of dynamic movement into consideration in response to the particular type of insect being selected with, e.g., pull down menu 302 of FIG. 3A.

Because NCR move less than WCR, the differential benefits of blended refuge compared to block refuge for NCR should be equal or greater than what was observed for WCR. In addition, the exemplary model was configured to assume one generation of CRW per year. In some portions of the Corn Belt, a significant proportion of NCR populations exhibit extended egg diapause, which reduces selection pressure on this species. This may be used to provide further conservatism in the modeling results. Further, given the relatedness of WCR and MCR (ssp.), as well as the similarity in efficacy of maize 59122 to both, a blended corn rootworm refuge is also applicable to MCR.

Models in accordance with some embodiments may suggest that a blending refuge provides many advantages and facilitates the durability of the trait. For example, a blending refuge may eliminate any uncertainties of adult CRW random mating by producing refuge beetles throughout the field in close proximity to any putatively resistant individuals that may emerge. Blending maximizes the potential for random mating with rare resistant individuals, thereby extending durability. Blending refuge also has the obvious benefits of removing compliance risk associated with block refuge approaches.

### Example Application of the Simulation Model Used to Explore CRW Population Genetics and Dynamics

Some embodiments discussed herein can be used to create, for example, a model of CRW population genetics and dynamics in a landscape of continuous maize to explore the evolution of resistance to maize 59122. Such a model can be configured to combine, for example, an adult dynamic movement submodel, calculated on a daily time step (including, e.g., adult emergence, dispersal, mating and oviposition), with a larval submodel calculated once per generation (including, e.g., larval movement and survival). In these exemplary model simulations, one or more parameters can be predefined (by, e.g., user 114 and/or whomever configures model executor 116) that assumes, for example, resistant CRW possesses a single di-allelic, autosomal gene that confers resistance to event maize 59122.

The model may consist of a grid representing 100 m×100 m (e.g., one hectare) sub-units (e.g., cells) within a field or set of fields. The model may also include one or more parameters that limit the model to, e.g., 50×50 cells for a total evaluation size of 2500 hectares. In some alternative or additional simulations, field size may be assumed to be a size of 4×10 cells (400 m×1000 m) or 40 hectares. Within a cell the WCR simulation model of Onstad may be implemented to capture larval population dynamics. See, e.g., the WCR simulation models of discussed in Onstad D. W., Modeling Larval Survival and Movement to Evaluate Seed Mixtures of Transgenic Corn for Control of Western Corn Rootworm (Coleoptera: Chrysomelidae), Journal of Economic Entomology 99: 1407-1414 (2006) (“Onstad (2006a)”). The adults, for example, may then be transitioned among cells in accordance to the results of the WCR adult movement, such as that discussed in the field study by Nowatzki et al. shown in the poster presented at the North Central Branch of the Entomological Society of America Meeting, Cincinnati, Ohio, on March 2003 (“Nowatzki et al. (2003b)”). Each cell can be modeled by computer system 100 as, for example, a refuge block, a maize 59122 block, or a maize 59122 block deployed with a 5% blended refuge. In some simulations, one or more parameters can be preconfigured to cause computer system 100 to assume that cells with maize 59122 contain 0.75% off types (non-maize 59122 seed). In some embodiments, computer system 100 may also be configured to assume blended refuge cells have the same percentage of off-type seeds in the maize 59122 component of the blend.

The model implemented by computer system 100 may model overwintering mortality that may occur during the egg and/or any other stage. A 50% overwintering mortality of the eggs may be preconfigured into computer system 100. See, e.g., Godfrey et al., Comparison of Western Corn Rootworm (Coleoptera: Chrysomelidae) Adult Populations and Economic Thresholds in First-Year and Continuous Corn Fields, J. Econ. Entomol, 76:1028-1032 (1983) (“Godfrey and Turpin 1983”) and Onstad 2006a. In the larval development and movement portion of the model, computer system 100 may associate an insect with, e.g., two life-stages, such as the early-stage larvae (e.g., first instars) and late-stage larvae (e.g., second and third instars). In such exemplary models, movement may occur with the early-stage larvae. “Function 15”, an algorithm for density dependent survival in Onstad et al. (2006b), may used by computer system 100 to control density-dependent mortality.

In some embodiments, computer system may omit modeling various aspects of the insect and/or plant development. For example, predispersal tasting mortality for the larvae may not be modeled in accordance with some embodiments. As another example, computer system 100 may be configured to avoid modeling pupae that may be in a resting, non-feeding, and transformational life-stage.

In some embodiments, computer system 100 may be configured to model adults that overwinter emerge, mate and lay eggs. The rules implemented by computer system 100 to model the emergence of male and female adults may be based upon emergence phenology curves, which may show that males emerge on average seven days prior to females. For susceptible and heterozygous individuals, computer system 100 may be configured to further delay the emergence by seven days for both sexes when they develop on Bt maize. Homozygous resistant individuals may be assumed by computer system 100 not to have delayed emergence in Bt maize (as compared to emergence in other plant matter). Under field conditions, essentially all females observed or collected in copula were teneral (i.e., less than 24 hours old). See, e.g., Hill R. E., Mating, Oviposition Patterns, Fecundity and Longevity of the Western Corn Rootworm, J. Econ. Entomol, 68:311-315 (1975) (“Hill 1975”) and Quiring et al., Influence of Reproductive Ecology on Feasibility of Mass Trapping Diabrotica Virgifera Virgifera (Coleoptera: Chrysomelidae), J. Appl. Ecology 27:965-982 (1990) (“Quiring and Timmins 1990”). In this regard, the model implemented by computer system 100 in accordance with some embodiments may omit any rules and/or other algorithms that track whether or not males actually mate, and instead include rules and/or other parameters that assume that there was an excess of males to mate with the females, because CRW males are capable of mating multiple times, whereas females generally mate once (Quiring and Timmins 1990, Onstad et al. 2001). Thus, the modeling of mating may be random in each cell. A 13-day pre-oviposition period and daily oviposition rate may also be modeled by computer system 100. See, e.g., Hill (1975) and Branson et al., Adult Western Corn Rootworms: Oviposition, Fecundity, and Longevity in the Laboratory, J. Econ. Entomol, 66: 417-418 (1973) (“Branson and Johnson 1973”). Computer system 100 may also be configured to include rules that assume oviposition occurs uniformly throughout a cell.

In some embodiments, dynamic movement data received as in input to the model may include, for example, beetle movement rates may be modeled based upon, e.g., three biologically relevant time periods during the CRW emergence phenology curve: (1) male movement (m/day) during the period when 10% or less of the females had emerged from non-Bt maize; (2) male and female movement (m/day) during the period of peak female emergence from non-Bt maize (defined as the period when 40-70% cumulative female emergence occurred); and (3) late-season male and female movement (m/day) (defined as the period after which 90% of the females had emerged from non-Bt maize). The dynamic movement data may also include beetle movement distance, which may be modeled by system 100 in accordance with, e.g., calculations involving a refined analysis of a rubidium mark-recapture movement study in Nowatzki et al. (2003a and 2003b) that found to average 15 m/day. Based on data reported by Quiring and Timmins (1990) and Nowatzki et al. (2003b), the model implemented by computer system 100 may include preconfigured rules that specify female beetles mate within a few meters of their emergence site.

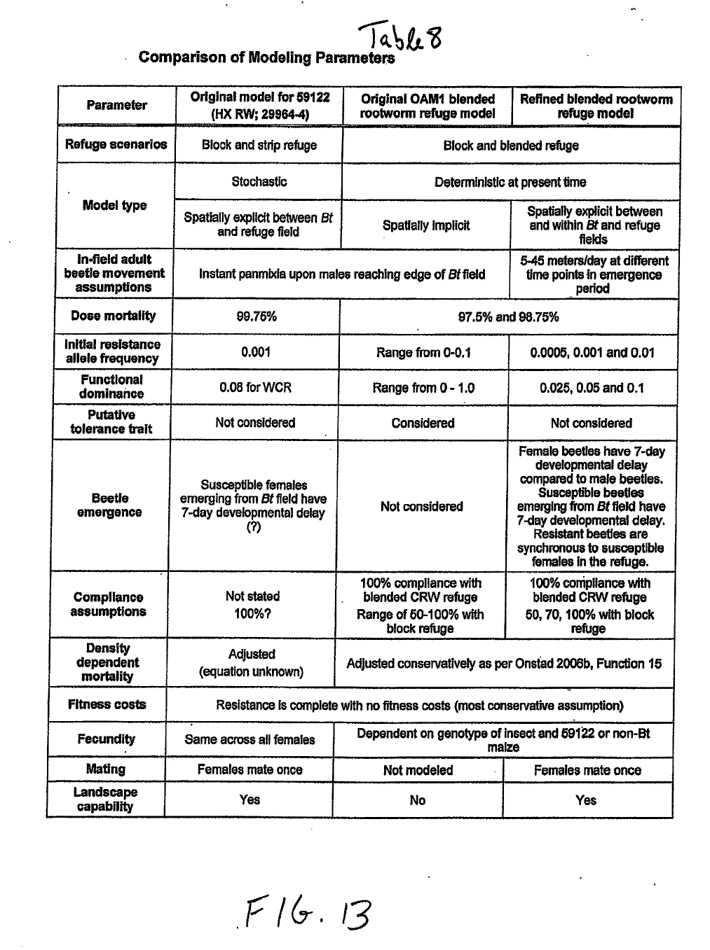

A set of benchmark parameters may be implemented by computer system 100 that are based on published and unpublished field studies, such as those provided in the tables describing each sensitivity analysis shown in Table 1 through Table 7 of FIG. 6 through FIG. 12, respectively. See, e.g., Lefko et al. 2008a. Table 8 of FIG. 13 shows a comparison of exemplary parameters that may be used in a modeling output to those used in an earlier modeling report. See, e.g., MRID 473567-08 and Storer N. P., A Spatially Explicit Model Simulating Western Corn Rootworm (Coleoptera: Chrysomelidae) Adaptation to Insect-Resistant Maize, J. Econ. Entomol, 96, 1530-1547 (2003) (“Storer 2003”).

One of the benefits that may be realized from using a blended corn rootworm refuge is that compliance with refuge requirements may be assured. Therefore, a compliance rate of 100% was assumed in all blended refuge scenarios. Compliance rates of 50%, 70% and 100% were used for block refuge scenarios.

Durability, namely the duration that the resistance allele frequency remains below 50% in some embodiments, may be used by computer system 100 as the modeling endpoint and be calculated for each modeling scenario. An efficient insect resistance management (“IRM)” plan may assist in maintaining the durability of a genetic trait for greater than 10 years. See, e.g., International Life Sciences Institute of Health and Environmental Sciences, An Evaluation of Insect Resistance Management in Bt Field Corn: A Science-Based Framework for Risk Assessment and Risk Management, Report of an Expert Panel, ILSI Press, Washington, D.C. (1999) (“ILSI 1999”).

The model code may be verified to confirm the expected behavior of the model for extreme scenarios. Additionally, a sensitivity analysis may be conducted to assess the behavior of the various new input parameters and/or parameters whose sensitivity may have changed due to the addition of the dynamic movement data and/or other parameters. See, e.g., Table 1 through Table 7 of FIG. 6 through FIG. 12.

In some embodiments, four refuge deployment strategies may be modeled, such as for example: (1) maize 59122 fields with a 20% block refuge planted in the same location each year with 100% compliance; (2) maize 59122 fields with a 20% block refuge planted in different locations yearly with 70% compliance; (3) maize 59122 fields planted with a 5% blended refuge; and (4) maize 59122 fields with no refuge.

In addition, the model may also be configured to examine the durability of maize 59122 when block refuges are used for a fixed time period prior to implementation of a blended refuge. For example, a first scenario may include a 20% block refuge planted in the same location with 100% compliance for four consecutive years followed by a 5% blended refuge in the following planting seasons. As another example, a second scenario may include a 20% block refuge planted in different locations with non-compliance in the fourth year followed by a 5% blended refuge in the following seasons.

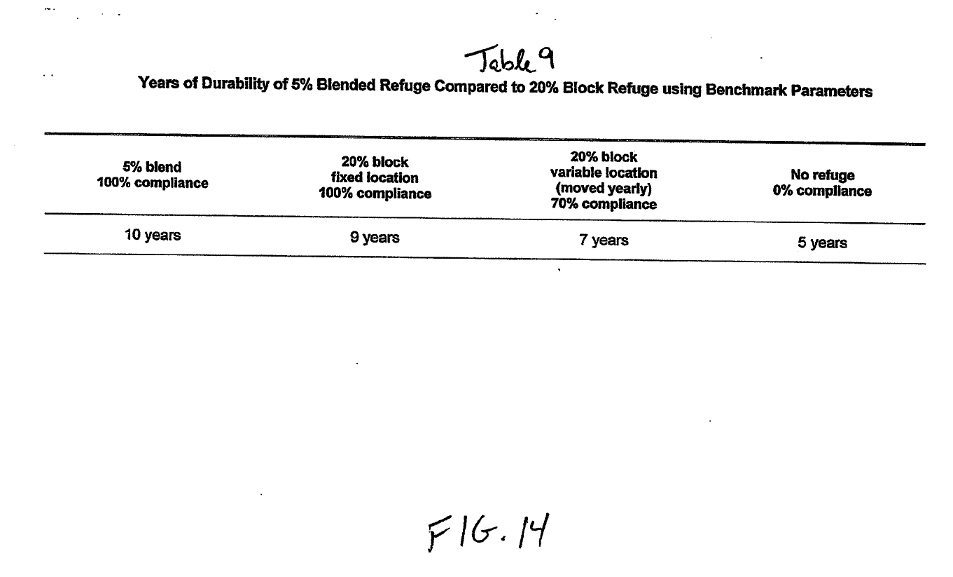

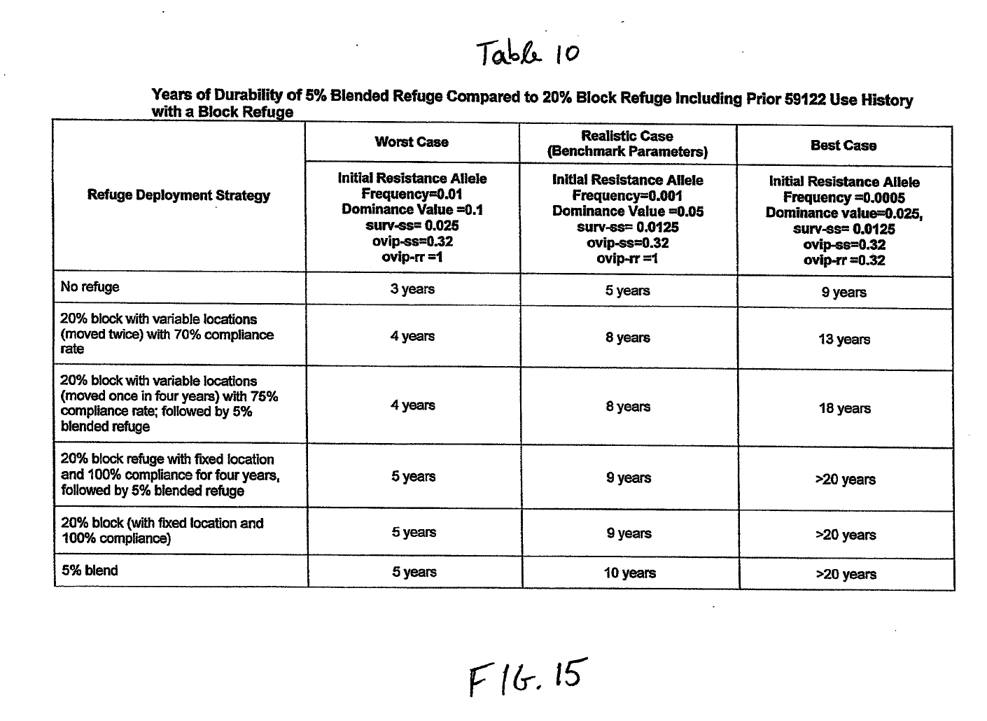

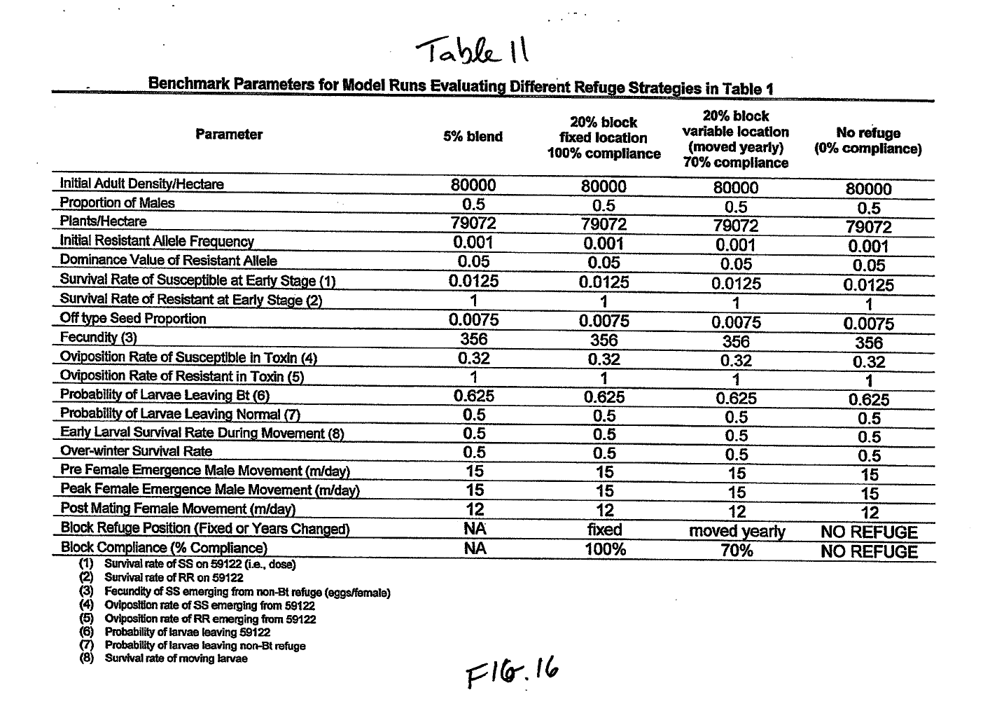

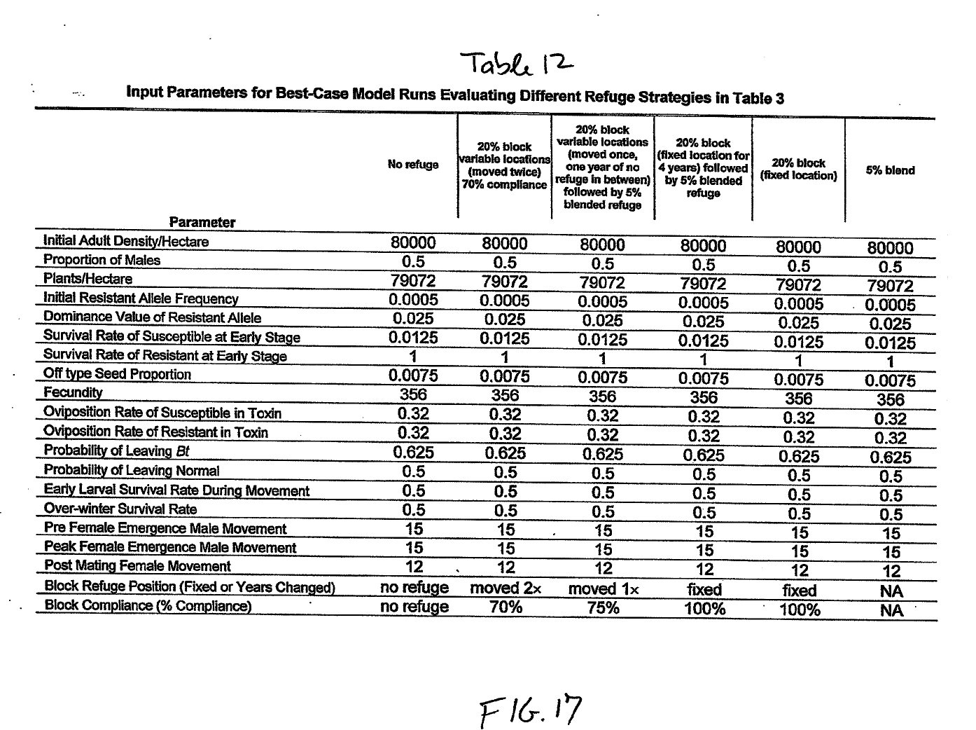

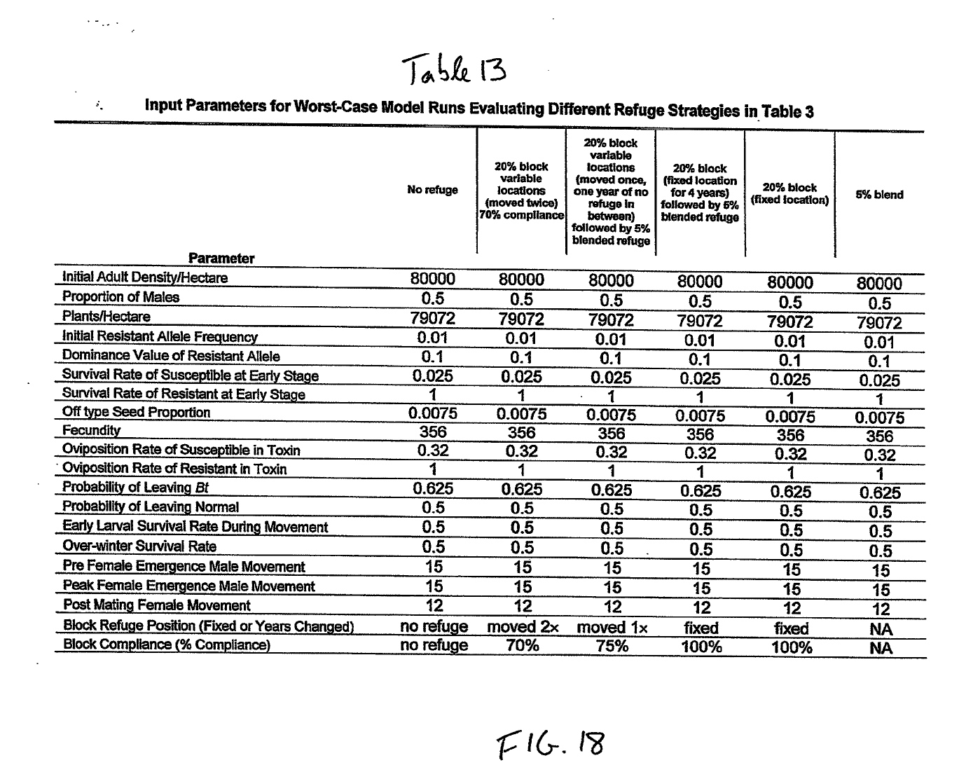

Examples of modeling output that predict durability in accordance with some embodiments is shown in Table 9 and Table 10 of FIGS. 14 and 15, respectively. Parameter inputs are shown in Table 11, Table 12 and Table 13 of FIGS. 16, 17 and 18, respectively, which may be used to generate the outputs shown in Table 9 and Table 10 of FIGS. 14 and 15. Additional outputs from the sensitivity analyses are shown in Table 1 through Table 7.

For example, the results of the four refuge deployment strategies are presented in Table 9 of FIG. 14 with input parameters presented in Table 11 of FIG. 16. These results demonstrate that the 5% seed blend has a predicted durability of 10 years, a 20% block with fixed location and 100% compliance has a predicted durability of 9 years, a 20% block that is moved yearly with 70% compliance has a predicted durability of 7 years, and a planting of maize 59122 with no refuge has a predicted durability of only 5 years.

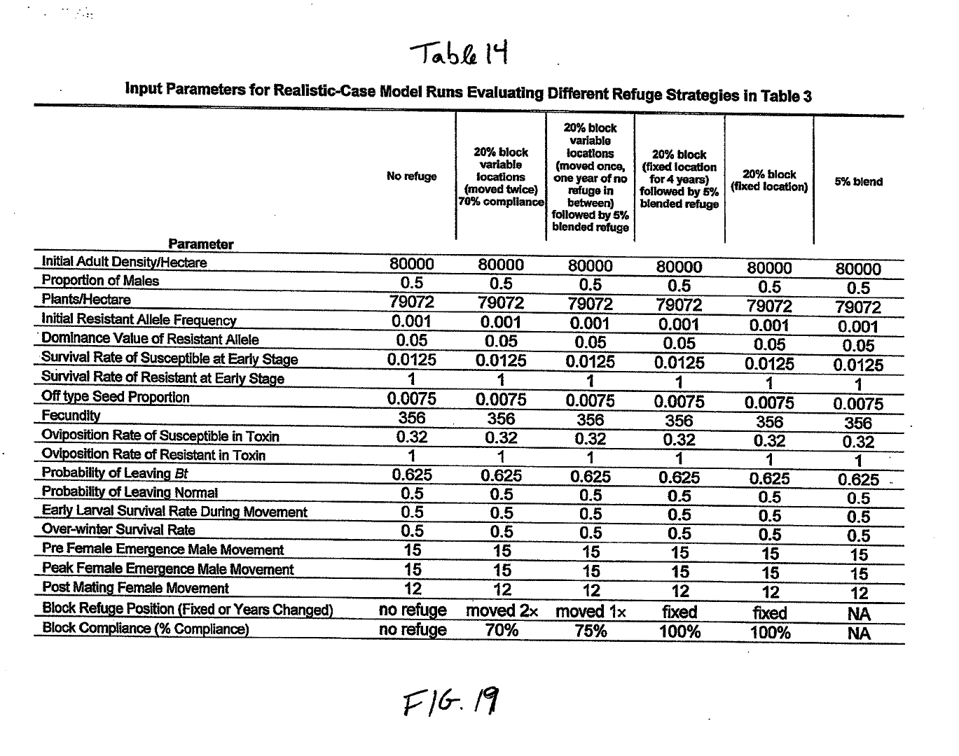

The model implanted by computer system 100 may evaluate scenarios using block refuge prior to deploying a blended refuge, as shown by Table 10 of FIG. 15. The outputs shown in Table 10 may be based on the input parameters shown in Table 12 (best-case), Table 13 (worst-case) and Table 14 (realistic-case) of FIG. 19. The use of a blended refuge following a block refuge may maintain and/or extend the durability of maize 59122 relative to continuation of a block refuge. Therefore, moving to a blended refuge may extend the durability of existing maize 59122 products.

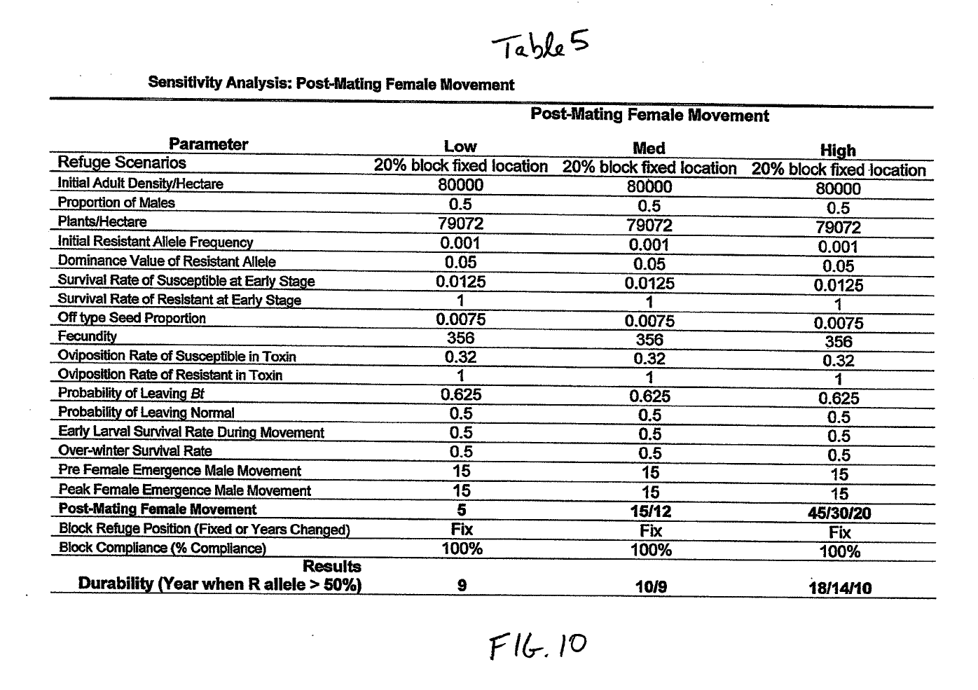

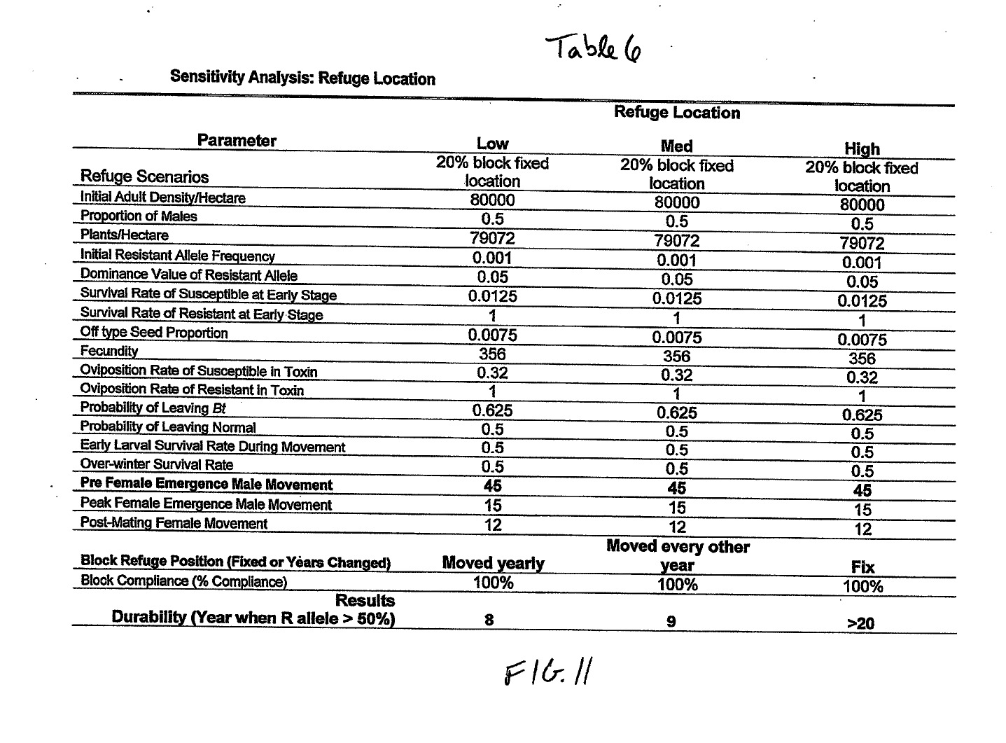

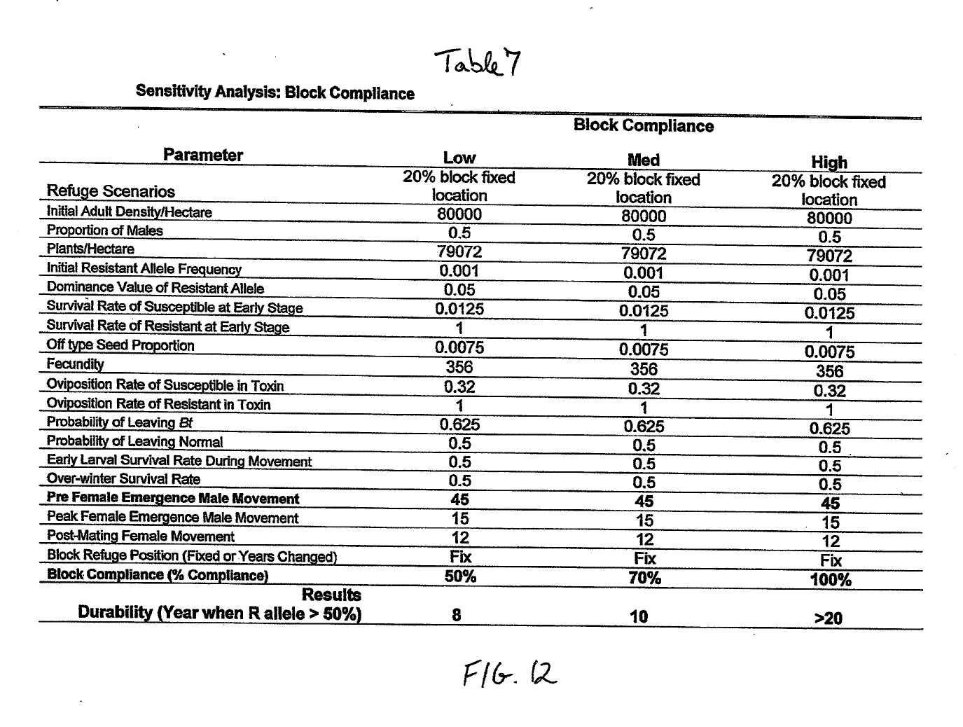

A sensitivity analysis may be conducted on, for example,: initial adult density/hectare (Table 1 of FIG. 6); over-winter survival rate (Table 2 of FIG. 7); dynamic movement of males prior to female emergence (Table 3 of FIG. 8); dynamic movement of males during peak female emergence (Table 4 of FIG. 9); post-mating dynamic movement of females (Table 5 of FIG. 10); refuge location (Table 6 of FIG. 11); and block compliance (Table 7 of FIG. 12).

All sensitivity analyses may be conducted, for example, under the 20% block refuge scenario. Tables 1-7 show that, in some embodiments, the most sensitive parameters of some exemplary models are over-winter survival rate, dynamic movement of males prior to female emergence, post-mating dynamic movement of females, refuge location and block compliance.

These exemplary models may be relatively insensitive to initial adult density/hectare and dynamic movement of males during peak female emergence.

The exemplary results demonstrate, for example, the relative superiority of the 5% blended refuge as compared to other refuge deployment strategies. Maize 59122 planted with a 20% block refuge planted in exactly the same location year after year with best-case parameter estimates may have, for example, greater than 20 years of predicted durability (see, e.g., Table 6 of FIG. 11), because resistance in this situation may only arise due to spontaneous random mutation, which may be omitted from models in accordance with some embodiments. However, close inspection of the outputs produced by some embodiments show that high susceptible beetle populations may be maintained only in the refuge block. Depending upon the dimensions of the field inputted into computer system 100, there can be areas of a maize 59122 field inaccessible to refuge beetles. These distant ends of the maize 59122 field may be modeled as zones of continuous selection that have expected durabilities similar to, e.g., the no-refuge scenario of five years. Thus, although the some models may suggest that the block refuge can have good durability in a best-case scenario, it may lead to unintentional selection for resistance in these “hot spots.” Alternatively, with a 5% blended refuge, some models suggest that there may never be a risk of hot spots with unintentional selection because susceptible CRW males emerging from refuge plants will be in close proximity to any female beetles that emerge from maize 59122 plants anywhere in the field. Moreover, some model outputs suggest that blending refuge ensures 100% compliance with CRW refuge requirements without the grower having to incur any extra work, planning or expense.

Population genetics models in accordance with some embodiments, including the present model, that are based on single genes are extremely sensitive to the interplay between dose mortality, initial frequency and dominance values. For example, maize 59122's initial frequency and dominance of resistance may be omitted from some models in accordance with some embodiments discussed herein. Some exemplary model output may be based on realistic estimates, erring on the side of conservatism. Using less conservative estimates may increase the number of years of durability.

The results shown in the drawings may be most applicable to areas where maize is produced in a continuous cropping pattern (i.e., maize-on-maize) and to those areas containing the soybean biotype of the WCR, because their ability to oviposit in soybean mimics a continuous maize cropping system. These conditions represent landscapes with high CRW populations (and as a result, the highest concentration of continued CRW trait use) and should be considered a worst-case scenario. The exemplary results shown in the drawings do not necessarily represent the commonly used maize production system of maize-soybean crop rotation (or any other crop rotation system) where the soybean biotype is not present. In situations where crop rotation is still a successful management alternative, durability may be greatly extended compared to the results shown.

The results shown in the drawings indicate that a 5% blended refuge provides substantially less risk to maize 59122 durability than a 20% block refuge under the shown modeling scenarios. Best- and worst-case scenarios modeled show that a 5% blended refuge can increase durability from 10 to 100% (dependent on refuge placement within a field and compliance) when compared to a 20% block refuge.

Further, the results shown in the drawings discussed herein demonstrate the superiority of a 5% blended refuge relative to block refuge deployment strategies for maize 59122. Based upon these results, a blended corn rootworm refuge, which may ensure 100% corn rootworm refuge compliance, may provide the most effective tool that the grower can use to delay the development of corn rootworm resistance to maize 59122.

What is claimed is:

1. A method of modeling damage to plants caused by pests, comprising:
receiving one or more input parameters comprising:
genetic traits of the plants,
pest information associated with the pests,
field information associated with one or more fields where the plants and the pests meet; and
dynamic movement data associated with how the pests move within a field that includes the plants having the genetic traits;
executing a computer-implemented model, using circuitry, based on the one or more input parameters, wherein executing the computer-implemented model comprises modeling dynamic movement of the pests in the one or more fields;
determining durability of the genetic traits based on the dynamic movement of the pests; and
outputting output information associated with the durability.

2. The method of claim 1, wherein receiving the genetic traits of the plants comprises receiving at least one minor gene.

3. The method of claim 1, wherein:
receiving the input parameters comprises receiving the genetic traits of the plants include transgenic pest resistant plant data.

4. The method of claim 1, wherein executing the computer-implemented model comprises modeling blended refuge seed products.

5. The method of claim 1, wherein outputting the output information comprises outputting allele frequencies.

6. The method of claim 1, wherein outputting the output information comprises outputting a number of generations.

7. The method of claim 1, wherein the receiving the one or more input parameters comprises receiving one or more initial allele frequencies.

8. The method of claim 1, wherein outputting the output information comprises outputting a number of genotypes in each life stage of each generation and associated allele frequencies.

9. The method of claim 1 further comprises modeling a plurality of stages of development of the pests.

10. The method of claim 1 further comprises dividing each of the one or more fields into a plurality of cells.

11. The method of claim 1, wherein receiving the one or more input parameters comprises receiving the pest information indicating the pests are at least one of coleopteran and corn rootworm.

12. The method of claim 1 further comprises stochastic modeling.

13. A system configured to model damage to plants caused by pests, comprising:
an input component configured to receive one or more input parameters comprising:
genetic traits of the plants,
pest information associated with the pests, and
field information associated with one or more fields where the plants and the pests meet;
a processor configured to:
execute a computer-implemented model based on the one or more input parameters, the input parameters comprising dynamic movement data associated with how the pests move within a field that includes the plants having the genetic traits; and
model dynamic movement of the pests based on the movement data;
determine durability of the genetic traits based on the dynamic movement of the pests; and
an output component configured to present output information associated with the durability.

14. The system of claim 13, wherein the genetic traits of the plants comprise at least one minor gene.

15. The system of claim 13, wherein the genetic traits of the plants include transgenic pest resistant plant data.

16. The system of claim 13, wherein the processor is further configured to model blended refuge seed products.

17. The system of claim 13, wherein the output information comprises allele frequencies.

18. The system of claim 13, wherein the output information comprises a plurality of generations.

19. The system of claim 13, wherein the one or more input parameters comprises one or more initial allele frequencies.

20. The system of claim 13, wherein the output information comprises a number of genotypes in each life stage of each generation and associated allele frequencies.

21. The system of claim 13, wherein the processor is further configured to model a plurality of stages of development of the pests.

22. The system of claim 13, wherein the processor is further configured to divide each of the one or more fields into a plurality of cells.

23. The system of claim 13, wherein the one or more input parameters comprises the pest information indicating the pests are at least one of coleopteran and corn rootworm.

24. The system of claim 13, wherein the processor is further configured to perform stochastic modeling.

25. A method of evaluating durability of genetic traits to the control of damage by coleopteran insects, comprising:
receiving one or more input parameters associated with:
the genetic traits,
the coleopteran insects, and
one or more fields;
executing a computer-implemented model, using circuitry, based on the one or more parameters, wherein the executing the computer-implemented model includes:
determining how many of the coleopteran insects become adults;
determining the location of the adults; and
modeling dynamic movement of the adults within and between the one or more fields;
determining durability of the genetic traits based on the dynamic movement of the adults; and
outputting output information associated with the durability.
